(19) United States
(12) Patent Application Publication
(10) Pub. No.: US 2026/0172897 A1
(43) Pub. Date: Jun. 18, 2026

(54) CONDITIONAL INCLUSION OF POLL BITS IN DATA PACKETS AND RETRANSMISSION OF DATA PACKETS AT A RADIO LINK CONTROL LAYER

(71) Applicant: Lenovo (United States) Inc., Morrisville, NC (US)

(72) Inventors: Shwetha Sreejith, Steinbach (DE); Joachim Löhr, Wiesbaden (DE)

(73) Assignee: Lenovo (United States) Inc., Morrisville, NC (US)

(21) Appl. No.: 18/984,656

(22) Filed: Dec. 17, 2024

(51) Int. Cl. H04W 28/06; H04L 1/18

(52) U.S. Cl. CPC H04W 28/06; H04L 1/18

(57) ABSTRACT

Various aspects of the present disclosure relate to conditional inclusion of poll bits in data packets and retransmission of data packets at a radio link control (RLC) layer. A user equipment (UE) may receive signaling that indicates a set of conditions for managing (e.g., enabling or canceling) enhanced polling at an RLC layer of the UE and/or managing (e.g., transmitting or canceling) one or more retransmissions of the data packet at the RLC layer of the UE. The UE may manage, based on one or more first conditions being satisfied, inclusion of a poll bit for enhanced polling in the header of the data packet at the RLC layer of the UE. The UE may cancel, based on a status report for the data packet and one or more second conditions being satisfied, the one or more retransmissions of the data packet at the RLC layer of the UE.

### TECHNICAL FIELD

The present disclosure relates to wireless communications, and more specifically to polling for data packets and retransmission of data packets.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive signaling that indicates a set of conditions associated with at least one of the UE managing (e.g., enabling, activating, canceling disabling, deactivating) inclusion of a poll bit in a header of a data packet at a radio link control (RLC) layer of the UE or the UE managing (e.g., transmitting, canceling) one or more retransmissions of the data packet at the RLC layer of the UE, manage, based on one or more first conditions of the set of conditions being satisfied, the inclusion of the poll bit in the header of the data packet at the RLC layer of the UE, and cancel, based on one or more second conditions of the set of conditions being satisfied, the one or more retransmissions of the data packet at the RLC layer of the UE, where the one or more second conditions of the set of conditions are satisfied based on a status report corresponding to the data packet.

A processor (e.g., a standalone processor chipset, or a component of a UE) for wireless communication is described. The processor may be configured to, capable of, or operable to perform one or more operations as described herein. For example, the processor may be configured to, capable of, or operable to receive signaling that indicates a set of conditions associated with at least one of the UE managing inclusion of a poll bit in a header of a data packet at an RLC layer of the UE or the UE managing one or more retransmissions of the data packet at the RLC layer of the UE, manage, based on one or more first conditions of the set of conditions being satisfied, the inclusion of the poll bit in the header of the data packet at the RLC layer of the UE, and cancel, based on one or more second conditions of the set of conditions being satisfied, the one or more retransmissions of the data packet at the RLC layer of the UE, where the one or more second conditions of the set of conditions are satisfied based on a status report corresponding to the data packet.

A method performed or performable by a UE for wireless communication is described. The method may include receiving signaling that indicates a set of conditions associated with at least one of the UE managing inclusion of a poll bit in a header of a data packet at an RLC layer of the UE or the UE managing one or more retransmissions of the data packet at the RLC layer of the UE, managing, based on one or more first conditions of the set of conditions being satisfied, the inclusion of the poll bit in the header of the data packet at the RLC layer of the UE, and canceling, based on one or more second conditions of the set of conditions being satisfied, the one or more retransmissions of the data packet at the RLC layer of the UE, where the one or more second conditions of the set of conditions are satisfied based on a status report corresponding to the data packet.

In some implementations of the UE, the processor, and the method described herein, the set of conditions includes at least one of a first threshold duration corresponding to including the poll bit in the header of the data packet at the RLC layer of the UE, a second threshold duration corresponding to transmitting the one or more retransmissions of the data packet at the RLC layer of the UE, a third threshold duration corresponding to canceling the one or more retransmissions of the data packet at the RLC layer of the UE, a fourth threshold duration corresponding to canceling the inclusion of the poll bit in the header of the data packet at the RLC layer of the UE, or a threshold importance value of the data packet. In some implementations of the UE, the processor, and the method described herein, one or more of the first threshold duration is offset from the second threshold duration based on a minimum time associated with receiving the status report after transmitting the data packet including the poll bit, the second threshold duration is based on a minimum time associated with receiving the data packet at the RLC layer of the UE, the third threshold duration is based on a minimum time between a retransmission of the data packet and the one or more retransmissions of the data packet, or the fourth threshold duration is based on a minimum time between a retransmission of the data packet and a transmission of the data packet including the poll bit in the header of the data packet. In some implementations of the UE, the processor, and the method described herein, the first threshold duration is a same value as the second threshold duration.

In some implementations of the UE, the processor, and the method described herein, the signaling includes radio resource control (RRC) signaling, where the set of conditions are configured in at least one of a packet data convergence protocol (PDCP) information element (IE) or an RLC IE, and where one or more of the PDCP IE includes an autonomous retransmission timer parameter, the PDCP IE includes an enhanced polling timer parameter, the RLC IE includes an autonomous retransmission threshold parameter, or the RLC IE includes a delay critical poll parameter. In some implementations of the UE, the processor, and the method described herein, to cancel the one or more retransmissions of the data packet at the RLC layer of the UE, the UE, the processor, and the method may further be configured to, capable of, or operable to receive the status report, where the status report includes a negative acknowledgment (NACK) corresponding to the data packet, where at least one of the one or more first conditions or the one or more second conditions are satisfied based on the status report including the NACK corresponding to the data packet, and where the NACK triggers a retransmission of the data packet. In some implementations of the UE, the processor, and the method described herein, to manage the inclusion of the poll bit in the header of the data packet, the UE, the processor, and the method may further be configured to, capable of, or operable to include the poll bit in the header of the data packet, and receive, responsive to the poll bit, the status report, where the status report includes at least one of an acknowledgement (ACK) or NACK corresponding to the data packet. In some implementations of the UE, the processor, and the method described herein, to cancel the one or more retransmissions of the data packet at the RLC layer of the UE, the UE, the processor, and the method may further be configured to, capable of, or operable to retransmit the data packet based on the status report including the NACK, where the one or more second conditions include the status report including the NACK.

In some implementations of the UE, the processor, and the method described herein, the UE, the processor, and the method may further be configured to, capable of, or operable to transmit, independent of the status report, one or more additional retransmissions of the data packet. In some implementations of the UE, the processor, and the method described herein, to manage the inclusion of the poll bit in the header of the data packet, the UE, the processor, and the method may further be configured to, capable of, or operable to receive, after the one or more retransmissions of the data packet, the status report, where the status report includes a NACK corresponding to the data packet, and where the one or more second conditions include the status report including the NACK, and cancel, based on the status report, the one or more additional retransmissions of the data packet at the RLC layer of the UE. In some implementations of the UE, the processor, and the method described herein, the UE, the processor, and the method may further be configured to, capable of, or operable to discard, after the one or more additional retransmissions of the data packet and independent of the status report corresponding to the data packet, the data packet, and update a transmission window associated with the data packet. In some implementations of the UE, the processor, and the method described herein, the UE, the processor, and the method may further be configured to, capable of, or operable to receive the status report, where the status report includes a NACK corresponding to the one or more additional retransmissions of the data packet, and update, independent of the NACK, a transmission window associated with the data packet, where a reception window is based on at least one of a local timer, a first control data packet that indicates the reception window, a flag in the one or more additional retransmissions of the data packet that indicates the one or more retransmissions of the data packet are canceled, or a second control data packet that indicates the one or more retransmissions of the data packet are canceled.

An NE (e.g., a base station) for wireless communication is described. The NE may be configured to, capable of, or operable to perform one or more operations as described herein. For example, the NE may be configured to, capable of, or operable to transmit signaling that indicates a set of conditions for managing (e.g., enabling, activating, canceling, disabling, deactivating) inclusion of a poll bit in a header of a data packet at an RLC layer or for managing (e.g., transmitting, canceling) one or more retransmissions of the data packet at the RLC layer, and receive, based on one or more conditions of the set of conditions being satisfied, one or more of the data packet including the inclusion of the poll bit in the header of the data packet or the one or more retransmissions of the data packet.

A processor (e.g., a standalone processor chipset, or a component of a NE) for wireless communication is described. The processor may be configured to, capable of, or operable to perform one or more operations as described herein. For example, the processor may be configured to, capable of, or operable to transmit signaling that indicates a set of conditions for managing inclusion of a poll bit in a header of a data packet at an RLC layer or for managing one or more retransmissions of the data packet at the RLC layer, and receive, based on one or more conditions of the set of conditions being satisfied, one or more of the data packet including the inclusion of the poll bit in the header of the data packet or the one or more retransmissions of the data packet.

A method performed or performable by an NE (e.g., a base station) for wireless communication is described. The method may include transmitting signaling that indicates a set of conditions for managing inclusion of a poll bit in a header of a data packet at an RLC layer or for managing one or more retransmissions of the data packet at the RLC layer, and receiving, based on one or more conditions of the set of conditions being satisfied, one or more of the data packet including the inclusion of the poll bit in the header of the data packet or the one or more retransmissions of the data packet.

In some implementations of the NE, the processor, and the method described herein, the set of conditions includes at least one of a first threshold duration corresponding to including the poll bit in the header of the data packet at the RLC layer of the UE, a second threshold duration corresponding to receiving the one or more retransmissions of the data packet, a third threshold duration corresponding to canceling the one or more retransmissions of the data packet, a fourth threshold duration corresponding to canceling the inclusion of the poll bit in the header of the data packet at the RLC layer of the UE, or a threshold importance value of the data packet. In some implementations of the NE, the processor, and the method described herein, one or more of the first threshold duration is offset from the second threshold duration based on a minimum time associated with receiving a status report after transmitting the data packet including the poll bit, the second threshold duration is based on a minimum time associated with receiving the data packet, the third threshold duration is based on a minimum time between a retransmission of the data packet and the one or more retransmissions of the data packet, or the fourth threshold duration is based on a minimum time between a retransmission of the data packet and a transmission of the data packet including the poll bit in the header of the data packet. In some implementations of the NE, the processor, and the method described herein, the first threshold duration is a same value as the second threshold duration.

In some implementations of the NE, the processor, and the method described herein, the signaling includes RRC signaling, where the set of conditions are configured in at least one of a PDCP IE or an RLC IE, and where one or more of the PDCP IE includes an autonomous retransmission timer parameter, the PDCP IE includes an enhanced polling timer parameter, the RLC IE includes an autonomous retransmission threshold parameter, or the RLC IE includes a delay critical poll parameter. In some implementations of the NE, the processor, and the method described herein, the NE, the processor, and the method may further be configured to, capable of, or operable to transmit a status report including a NACK corresponding to the data packet, where one or more of the inclusion of the poll bit in the header of the data packet at the RLC layer of the UE is canceled or the one or more retransmissions of the data packet are canceled based on the NACK. In some implementations of the NE, the processor, and the method described herein, the data packet including the inclusion of the poll bit in the header of the data packet is received, and where the NE, the processor, and the method may further transmit, responsive to the poll bit, a status report including at least one of an ACK or NACK corresponding to the data packet.

In some implementations of the NE, the processor, and the method described herein, the NE, the processor, and the method may further be configured to, capable of, or operable to receive a retransmission of the data packet based on the status report including the NACK, where the one or more retransmissions of the data packet are canceled, and where the one or more conditions include the status report including the NACK. In some implementations of the NE, the processor, and the method described herein, the NE, the processor, and the method may further be configured to, capable of, or operable to receive, independent of a status report, one or more additional retransmissions of the data packet. In some implementations of the NE, the processor, and the method described herein, the NE, the processor, and the method may further be configured to, capable of, or operable to transmit the status report including a NACK corresponding to the one or more additional retransmissions of the data packet, and update a reception window associated with the data packet based on at least one of a local timer, a first control data packet that indicates the reception window, a flag in the one or more additional retransmissions of the data packet that indicates the one or more retransmissions of the data packet are canceled, or a second control data packet that indicates the one or more retransmissions of the data packet are canceled.

### BRIEF DESCRIPTION OF THE DRAWINGS

FIG. 1 illustrates an example of a wireless communications system in accordance with aspects of the present disclosure.

FIGS. 2 through 7 illustrate example transmission diagrams, in accordance with aspects of the present disclosure.

FIG. 8 illustrates an example signaling diagram, in accordance with aspects of the present disclosure.

FIGS. 9 through 11 illustrate example of configurations in accordance with aspects of the present disclosure.

FIG. 12 illustrates an example of a UE in accordance with aspects of the present disclosure.

FIG. 13 illustrates an example of a processor in accordance with aspects of the present disclosure.

FIG. 14 illustrates an example of an NE in accordance with aspects of the present disclosure.

FIG. 15 illustrates a flowchart of a method performed by a UE in accordance with aspects of the present disclosure.

FIG. 16 illustrates a flowchart of a method performed by an NE in accordance with aspects of the present disclosure.

### DETAILED DESCRIPTION

One or more devices in a wireless communications system, such as UEs and NEs (e.g., a base station, gNB), may support wireless communication (e.g., reception and/or transmission of wireless communication) using a layered architecture, referred to as a protocol stack. The protocol stack includes one or more layers that perform functions for transmitting and receiving data between the devices. For example, a user plane, also referred to as a data plane, carries one or more data packets, including extended reality (XR) data packets, voice calls, text messages, and internet data, among other examples. A protocol stack of the user plane includes a PDCP layer and an RLC layer, which work together to manage data packet delivery, retransmissions, and reordering.

In some examples, the PDCP layer and the RLC layer in the user plane protocol stack function independently from one another. For example, a receiving device maintains a reordering window at the PDCP layer to receive data (e.g., a PDCP protocol data units (PDUs)) and transmit the data to higher layers. The receiving device may also maintain a reception window at the RLC layer to receive data (e.g., RLC PDUs) and transmit the data to higher layers. The receiving device may use a timer to control the reordering window at the PDCP layer. For example, when the timer expires, a lower bound of the reordering window at the PDCP layer moves forward in time. If the receiving devices receives a data packet at the PDCP layer outside of the reordering window, then the receiving device discards the data packet. The receiving device may update (e.g., adapt, modify, adjust) a reception window at the RLC layer when an earliest data packet in the reception window has been received and the receiving device has transmitted an ACK for the earliest data packet. However, the reception window at the RLC layer and the reordering window at the PDCP layer may not be updated at a same time, leading to the RLC layer transmitting data packets to the PDCP layer that are outside of the reordering window at the PDCP layer. If the PDCP layer receives data packets outside of the reordering window, then the receiving device may discard the data packets. The receiving device discarding the data packets at the PDCP layer may result in inefficient use of communication resources (memory resources, processing resources, time-frequency resources, etc.) and increased latency at the user plane.

To reduce increased latency resulting from transmission of data packets to the PDCP layer that are outside of the reordering window at the PDCP layer, a NE may configure a UE to perform enhanced polling at an RLC layer of the UE, as well as autonomous retransmission at the RLC layer of the UE. For enhanced polling, a UE may set a poll bit in data packet header (e.g., for a delay-critical data packet) to request a status report from a device receiving the data packets. The UE may determine whether to retransmit the data packet according to the status report. Additionally, or alternatively, the UE may implement autonomous retransmission at the RLC layer of the UE, in which the UE transmits one or more retransmissions of a data packet (e.g., for a delay-critical data packet) without receiving a status report. However, enhanced polling and autonomous retransmission for data packets may increase signaling overhead at the RLC layer, leading to delays and congestion at the RLC layer. In some examples, the UE may continue to perform retransmissions in addition to the autonomous retransmissions and enhanced polling, leading to additional delays and congestion related to the data packet retransmissions.

As described herein, to improve latency by decreasing signaling overhead and improving efficiency of communication resource usage for data packet transmission at the RLC layer of a UE, a NE may configure one or more conditions that indicate for the UE to perform enhanced polling and/or autonomous retransmission. For example, if a first set of the conditions is met, then the UE may manage enhanced polling functionality at the RLC layer by enabling or canceling (e.g., disabling) the enhanced polling functionality, accordingly. Additionally, or alternatively, if a second set of conditions is met, then the UE may manage autonomous retransmissions by transmitting the autonomous transmissions and/or other retransmissions of the data packet or canceling the autonomous retransmissions and/or other retransmissions of the data packet at the RLC layer, accordingly. Example conditions include, but are not limited to, one or more threshold values for enabling enhanced polling, canceling enhanced polling, transmitting autonomous retransmissions and/or other retransmissions, canceling autonomous retransmissions and/or other retransmissions, or indicating an importance value of the data packet, among other examples. In some cases, the threshold values may define respective durations (e.g., time periods) from when the data packet is transmitted, and the conditions may be satisfied accordingly to whether the UE receives a status report before or after the threshold values.

By performing the described techniques, a device in a wireless communications system can improve efficiency of communication resource usage and reduce latency for data packet transmission at the RLC layer. For example, the device (e.g., a UE) may selectively enable or cancel enhanced polling and may selectively perform autonomous retransmissions according to configurable conditions, which may reduce signaling overhead by dynamically disabling and/or canceling the enhanced polling and autonomous retransmissions if the enhanced polling and the autonomous retransmission are redundant. Additionally, or alternatively, by dynamically implementing (e.g., enabling, transmitting) enhanced polling and autonomous retransmissions, the device may ensure the PDCP layer receives data packets inside of a reordering window, which reduces a number of data packets discarded at the PDCP layer and improves efficiency of use of communication resources.

Reference is made herein to communicating data or information, such as signaling indicating conditions for enhanced polling and autonomous retransmission that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

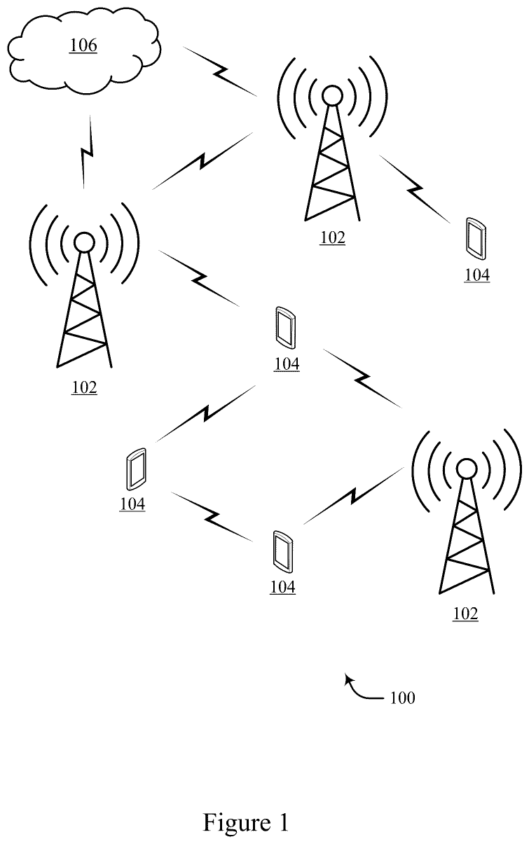

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a PDU session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix. A time interval of a resource (e.g., a communication resource) may be organized

according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots. In the wireless communications system 100, an electromagnetic (EM) spectrum may be

split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing. One or more devices (e.g., UEs 104 and NEs 102) in the wireless communications

system 100 may utilize a layered architecture known as a protocol stack to manage various aspects of data transmission and reception. The protocol stack may include multiple layers, where respective layers are responsible for functions in a communication process between the devices. Within the architecture, a user plane, also referred to as a data plane, manages the transmission of user data, such as voice calls, text messages, internet data, and XR data packets, among other examples. XR data packets may refer to data packets that include data related to XR applications or experiences. The XR data packets may include various types of information related to virtual reality (VR), augmented reality (AR), or mixed reality (MR) content. XR data packets may include, but are not limited to, visual data for rendering 3D environments, audio data for spatial sound, haptic feedback information, user input data, positional tracking data, or other sensor data. In some cases, a device may implement low latency transmission for the XR data packets to improve user experiences in real-time interactive environments.

The user plane protocol stack may include several layers, such as a PDCP layer and an RLC layer, to manage data packet delivery, retransmissions, and reordering. In some examples, a device receiving the data packets (e.g., a receiving device) and a device transmitting the data packets (e.g., a transmitting device) may both implement a user plane protocol stack. The receiving device may be an example of a UE 104 and/or a NE 102. Additionally, or alternatively, the transmitting device may be an example of a UE 104 and/or a NE 102. A PDCP layer at a receiving device may process and manage data packets, including performing header decompression, decryption, integrity verification, and in-order delivery of data packets to higher layers, among other examples. The PDCP layer at the receiving device may maintain a reordering window to provide for correct sequencing of incoming data packets and may discard data packets that are received outside of the reordering window. Additionally, or alternatively, the PDCP layer at the receiving device may perform duplicate data packet detection and elimination to prevent redundant processing of retransmitted data packets. In some other examples, a PDCP layer at a transmitting device may prepare data packets for transmission. The PDCP layer at the transmitting device may perform header compression, encryption, and integrity protection of outgoing data packets. In some cases, the PDCP layer at the transmitting device may perform packet segmentation and reassembly to accommodate different maximum transmission unit sizes across different network interfaces. The PDCP layer at the transmitting device may manage sequence numbering of data packets to facilitate proper ordering at the receiving device. In some cases, the PDCP layer at the transmitting device may implement mechanisms for handling retransmissions and status reporting to ensure reliable delivery of data packets.

In some cases, the PDCP and RLC layers in the user plane protocol stack function independently from one another. At a receiving device, the PDCP layer maintains a reordering window to receive PDCP data packets (e.g., PDUs) and transmit the PDCP data packets to higher layers. A PDCP PDUs may include user data or control information and may include headers added by the PDCP layer. At the RLC layer of a receiving device, an RLC entity at the receiving device (e.g., an RLC receiving entity) maintains a reception window to receive RLC data packets (e.g., PDUs) and transmit the RLC data packets to higher layers in the user plane protocol stack. Example higher layers may include, but are not limited to, an application layer, a transport layer, and a network layer, among other examples. At the PDCP layer, the reordering window is controlled by a timer (e.g., a t-Reordering timer) that is configured by signaling from a NE 102 (e.g., RRC signaling). When the timer expires, the reordering window moves (e.g., slides) forward. That is, a lower bound of the reordering window is updated to a later time. If a data packet is received outside of the reordering window, then the data packet is discarded by a PDCP entity at the receiving device (e.g., PDCP receiving entity).

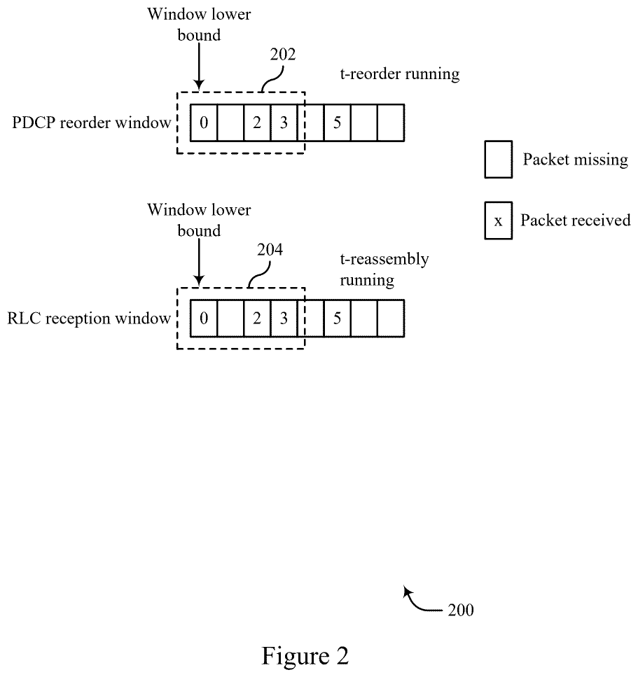

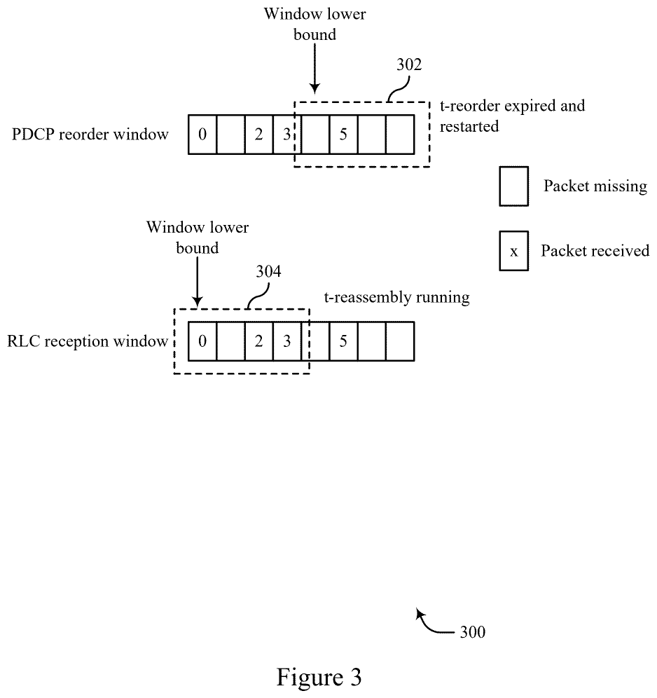

In some examples, the RLC layer may implement a mode of operation referred to as an RLC acknowledged mode (AM). In RLC AM mode, an RLC entity at a transmitting device (e.g., RLC transmitting entity) and an RLC receiving entity perform acknowledgment and/or retransmission of data packets to provide for reliable data delivery. For example, the RLC receiving entity slides a reception window when a lowest data packet in the window (e.g., a data packet with a sequence number that matches a lower bound of an RLC AM reception window) has been completely received and an ACK has been sent for the data packet. As the PDCP and RLC layers function independently, the reception window and reordering window may not be updated at a same time. If the PDCP reorder window moves forward while the RLC window is not updated, then the RLC layer may transmit data packets to the PDCP layer that are outside of the reordering window. The PDCP layer may discard data packets received outside of the reordering window, which is described in further detail with respect to FIGS. 2 and 3. The receiving device discarding the data packets at the PDCP layer may result in inefficient use of communication resources (memory resources, processing resources, time-frequency resources, etc.) and increased latency at the user plane.

To reduce increased latency resulting from transmission of data packets to the PDCP layer that are outside of the reordering window at the PDCP layer, a NE 102 may configure a UE 104 to perform enhanced polling at an RLC layer of the UE 104, as well as autonomous retransmission at the RLC layer of the UE 104. For enhanced polling, a UE 104 may set a poll bit in data packet header (e.g., for a delay-critical data packet) to request a status report from a device receiving the data packets. The UE 104 may determine whether to retransmit the data packet according to the status report. The UE 104 may set a poll bit for RLC PDUs based on one or more conditions, such as delay-criticality. For example, if a remaining time of an RLC PDU (e.g., based on a discardTimer parameter or a discardTimerForLowImportance parameter) falls below a threshold value, then the RLC transmitting entity sets a poll bit in a header of the RLC PDU to trigger a status report for the RLC PDU. If the status report for the RLC PDU that is delay-critical includes a NACK, then the RLC transmitting entity retransmits the data packet. If the status report for the RLC PDU that is delay-critical includes an ACK, then the RLC transmitting entity may discard the data packet (e.g., without retransmitting the data packet).

Additionally, or alternatively, the UE 104 may implement autonomous retransmission at the RLC layer of the UE 104, in which the UE 104 transmits one or more retransmissions of a data packet (e.g., for a delay-critical data packet) without receiving a status report. For example, the RLC transmitting entity may trigger a proactive retransmission of a data packet without receiving a status report for the data packet. The UE 104 may analyze one or more conditions (e.g., preconfigured, or defined conditions) to determine whether to autonomously retransmit the data packet (e.g., without receiving a status report). The conditions may include a delay-criticality of the data packet, among other examples. For example, if a remaining time of an RLC PDU (e.g., based on a discardTimer parameter or a discardTimerForLowImportance parameter) falls below a threshold value, then the RLC transmitting entity may retransmit the RLC PDU that is delay critical without waiting for a status report for the RLC PDU. The UE 104 may simultaneously (e.g., concurrently, at a same time) implement enhanced polling and autonomous retransmission.

However, transmitting poll bits that trigger status reports and retransmitting data packets may lead to increased signaling overhead and congestion at the RLC layer and PDCP layer. The increased signaling overhead and congestion may cause delays for transmission and reception of data packets, which degrades user experience. Additionally, or alternatively, the UE 104 may continue to perform retransmissions (e.g., according to conventional techniques) in addition to the autonomous retransmissions and enhanced polling, leading to additional delays and congestion related to the data packet retransmissions. According to implementations, one or more of the NEs 102 and the UEs 104 are operable to implement various aspects of the techniques described with reference to the present disclosure. In some examples, to improve delays and congestion related to enhanced polling and autonomous retransmission while increasing efficiency of resource usage related to discarding data packets at the PDCP layer, a NE 102 (e.g., a base station, gNB) may indicate one or more conditions to the UE 104 for implementing enhanced polling and/or autonomous retransmissions. The conditions may include, but are not limited to, one or more threshold values and/or criteria related to status reports for data packets. By selectively enabling or canceling enhanced polling and/or autonomous retransmission according to whether the conditions are met, the UE 104 (e.g., or other transmitting device) may reduce signaling overhead, avoid redundant transmissions, and decrease instances of discarded data packets at the PDCP layer.

Reference is made herein to communicating data or information, such as signaling configurations and/or conditions that are transmitted or received between devices. It is to be appreciated that other terms may be used interchangeably with communicating, such as signaling, transmitting, receiving, outputting, forwarding, retrieving, obtaining, and so forth.

FIG. 2 illustrates an example transmission diagram 200 in accordance with aspects of the present disclosure. In some examples, the transmission diagram 200 implements or is implemented by aspects of the wireless communications system 100. For example, the transmission diagram 200 may be implemented by a receiving device, which may be an example of a NE 102 and/or a UE 104 as described with reference to FIG. 1.

The transmission diagram 200 includes a reordering window at a PDCP layer, referred to as a PDCP reorder window 202, and a reception window at an RLC layer (e.g., in an RLC AM), referred to as an RLC reception window 204. A lower bound of the PDCP reorder window 202 and the RLC reception window 204 may align with a PDU with a sequence number parameter, SN, of zero (e.g., COUNT=0 for the PDCP layer, where COUNT=[HFN, SN]) and HFN is a hyper frame number parameter). As illustrated in the transmission diagram 200, an RLC receiving entity correctly and fully receives the data packets numbered 0, 2 and 3, and transmits the data packets to the PDCP layer. The PDCP layer receives the data packets numbered 0, 2 and 3, with a missing data packet number 1. Thus, the PDCP receiving entity starts a timer (e.g., t-Reordering timer) when the PDCP receiving entity receives the data packet number 2 before the data packet number 1. The RLC receiving entity starts a timer (e.g., a t-reassembly timer), as segments of the data packet number 1 are not received yet. When the t-Reordering timer expires at the PDCP layer, the PDCP receiving entity updates a lower bound of the PDCP reorder window 202 to a next consecutive data packet that is not received, which is described in further detail with respect to FIG. 3.

FIG. 3 illustrates an example transmission diagram 300 in accordance with aspects of the present disclosure. In some examples, the transmission diagram 300 implements or is implemented by aspects of the wireless communications system 100 and the transmission diagram 200. For example, the transmission diagram 300 may be implemented by a receiving device, which may be an example of a NE 102 and/or a UE 104 as described with reference to FIG. 1.

The transmission diagram 300 includes a PDCP reorder window 302 and an RLC reception window 304. A data packet number 4 is a next consecutive data packet that is not consecutively received after a t-Reordering timer expires. A lower bound of the PDCP reorder window 302 is moved to the data packet number 4, whereas in the RLC reception window 304, the t-reassembly timer triggers a status report upon expiry and the RLC reception window 304 does not update unless the status report includes an ACK for the data packet number 1. Since the RLC receiving entity has not received the data packet number 1, the RLC receiving entity attempts to recover the data packet by means of retransmissions. Once the data packet is recovered by the RLC receiving entity, the RLC receiving entity transmits the data packet to the PDCP layer. The PDCP layer discards the data packet, as the PDCP layer receives the data packet outside of the PDCP reorder window 302. Thus, the redundant transmissions are a waste of communication resources and may lead to increased latency for a user plane. In some examples, to improve communication resource usage and reduce latency, a NE may transmit signaling to a UE that configures conditions for dynamically performing enhanced polling and/or autonomous retransmissions.

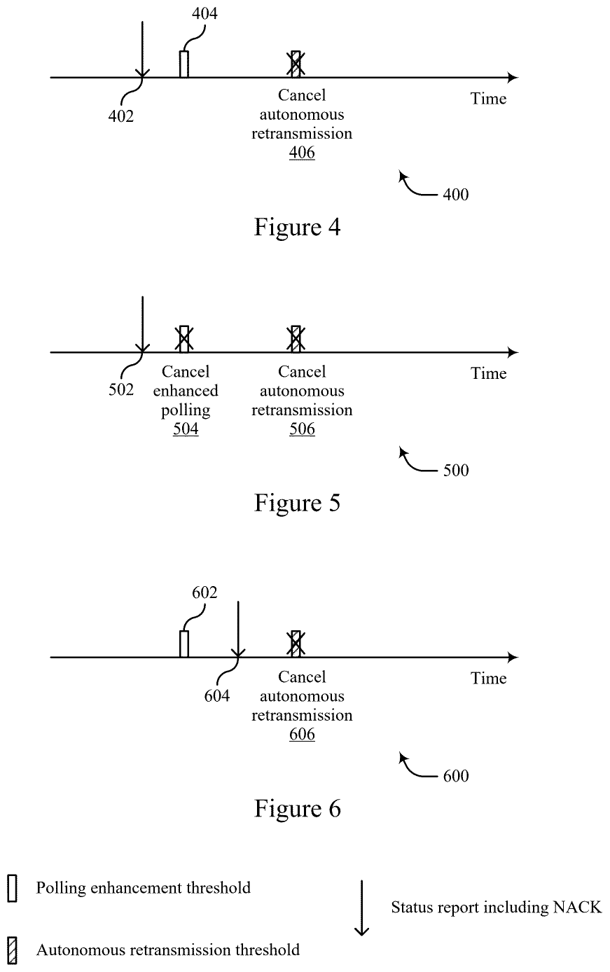

FIG. 4 illustrates an example transmission diagram 400 in accordance with aspects of the present disclosure. In some examples, the transmission diagram 400 implements or is implemented by aspects of the wireless communications system 100, the transmission diagram 200, and the transmission diagram 300. For example, the transmission diagram 400 may be implemented by a transmitting device, which may be an example of a NE 102 and/or a UE 104 as described with reference to FIG. 1. The transmission diagram 400 illustrates an example of canceling (e.g., disabling, not transmitting) one or more autonomous retransmissions according to conditions being met (e.g., satisfied).

In some examples, a UE may be configured to perform enhanced polling, as well as autonomous retransmissions (e.g., simultaneously, concurrently, at a same time) to provide for timely retransmissions at an RLC layer for latency sensitive applications (e.g., XR data packets). While implementing both enhanced polling and autonomous retransmission may be beneficial for an RLC receiving entity to successfully receive data packets in a timely manner (e.g., within a threshold duration), simultaneous enhanced polling and autonomous retransmission may lead to increased signaling overhead at the RLC layer and inefficient use of communication resources.

For enhanced polling, the UE may be configured with one or more conditions to include a poll-bit in a header of an RLC PDU, such that a status report is triggered upon reception of the poll-bit. An example condition may include a polling threshold value. For example, if a remaining time of an RLC data packet (e.g., based on a discardTimer parameter or a discardTimerforLowImportance parameter of a corresponding PDCP data packet) is below the polling threshold value, then the RLC transmitting entity includes a poll-bit in a next RLC data packet to be transmitted. In some cases, the data packet may be an example of a PDU or a service data unit (SDU). When the remaining time of the data packet falls below the threshold value, then the data packet may be referred to as delay critical. If the RLC receiving entity receives the poll-bit, then the RLC receiving entity triggers a status report transmission to a transmitting device. Upon reception of the status report, the RLC transmitting entity may retransmit the data packet if the status report includes a NACK or may discard the data packet if the status report includes an ACK. The RLC transmitting entity may update a transmission window, as described with reference to FIGS. 2 and 3.

For autonomous retransmissions, the UE may be configured with one or more conditions, such that the RLC transmitting entity may retransmit a data packet (e.g., a PDU) based on the fulfillment of the one or more conditions without waiting for a status report indicating a NACK for the data packet. In some examples, the conditions include a threshold value for the autonomous retransmissions (e.g., an autonomousReTx threshold parameter is configured). The RLC transmitting entity triggers an autonomous retransmission when a remaining delay of an RLC data packet is less than the configured threshold value. Autonomously retransmitting the data packet without a status report reduces delays associated with reception of a status reports at the RLC transmitting entity.

If the UE is simultaneously configured with both enhanced polling and autonomous retransmissions, then the UE may be configured with separate conditions for enhanced polling and autonomous retransmissions. That is, the one or more conditions may not be the same. For example, the delay-criticality threshold for enhanced polling may be different from the delay-criticality threshold for autonomous retransmissions. In some cases, the enhanced polling threshold may be set at an offset prior to the autonomous retransmission threshold. The offset may be based on the minimum time to receive a status report after triggering or submitting the enhanced polling (e.g., 0.5× round trip time (RTT)). That is, if an RLC data packet has a remaining time (e.g., based on the discardTimer parameter or the discardTimerForLowImportance parameter) value of 20 ms, then the enhanced polling threshold may be set for when the remaining time reaches 12 ms and autonomous retransmission threshold may be set for when the remaining time reaches 7 ms, where 5 ms is the minimum time for the RLC transmitting entity to receive a status report after triggering or submitting the enhanced polling. Additionally, or alternatively, the delay-criticality threshold for autonomous retransmissions may be based on minimum time for an RLC receiving entity to receive a data packet.

In some other examples, the one or more conditions for enhanced polling and autonomous retransmissions may be the same. For example, the delay-criticality threshold may be equal for enhanced polling and autonomous retransmissions, such that the RLC transmitting entity includes a poll-bit and triggers an autonomous retransmission simultaneously for a same RLC data packet (e.g., PDU). In some cases, the PDCP transmitting entity may inform the RLC transmitting entity by means of some cross-layer communication of the remaining time of a PDCP data packet (e.g., PDU). The RLC transmitting entity may infer the remaining time of the corresponding RLC data packet (e.g., SDU) from the remaining time of the PDCP data packet. The RLC transmitting entity may then use the remaining time information to trigger enhanced polling and/or autonomous retransmission, when configured.

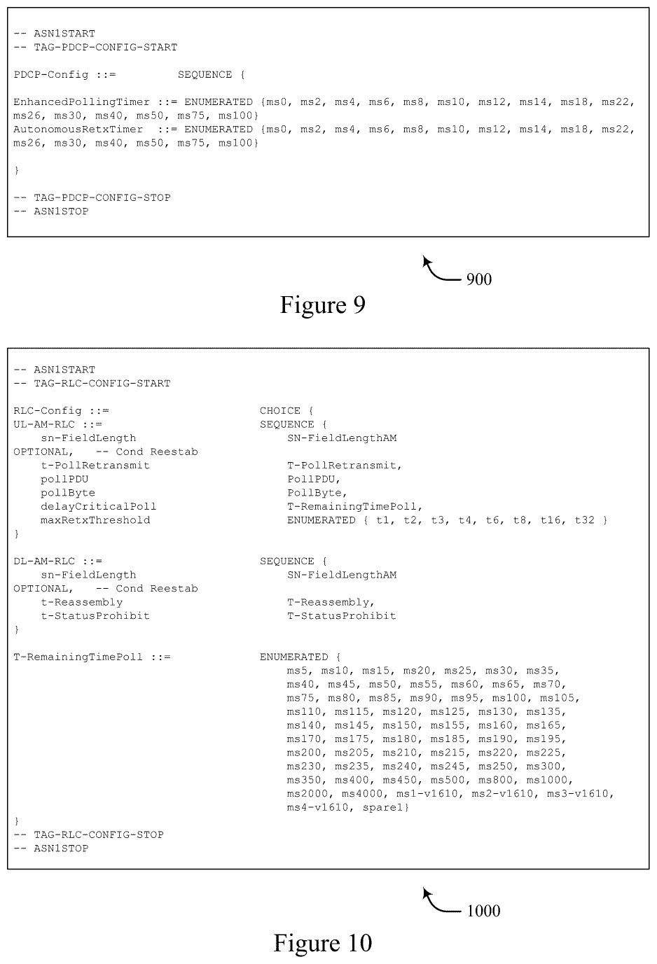

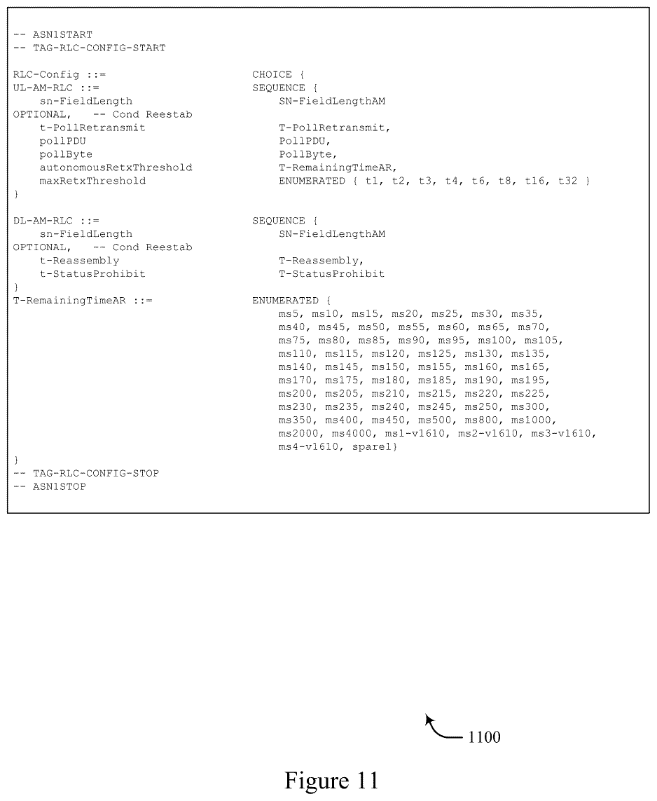

In some examples, a NE may include the timers for the enhanced polling threshold and autonomous retransmission threshold in a PDCP IE (e.g., PDCP-Config IE) via RRC signaling. For example, the enhanced polling may be configured as a new parameter (e.g., EnhancedPollingTimer) and autonomous retransmission may be configured as a new parameter (e.g., AutonomousRetxTimer), which is described in further detail with respect to FIG. 9. In some other examples, the NE may include an additional parameter (e.g., delayCriticalPoll) in an RLC IE (e.g., an RLC-Config IE) to point to a remaining time value for when the UE is to include a poll-bit. Additionally, or alternatively, the NE may include an additional parameter (e.g., T-RemainingTimePoll) in the RLC IE to indicate one or more different remaining time threshold values that trigger the enhanced polling, which is described in further detail with respect to FIG. 10. In some other examples, the NE may include an additional parameter in an RLC IE (e.g., autonomousRetxThreshold) to indicate a remaining time value for when the UE is to transmit an autonomous retransmission for a data packet and an additional parameter (e.g., T-RemainingTimeAR) to indicate one or more different remaining time threshold values for triggering autonomous retransmissions, which is described in further detail with respect to FIG. 11. The UE can apply the conditions to either one of enhanced polling or autonomous retransmissions.

If the UE is configured to implement enhanced polling and autonomous retransmissions simultaneously (e.g., concurrently, at a same time), then the NE may configure one or more additional conditions to reduce the polling and/or retransmissions at an RLC layer. The one or more additional conditions may be based on prior reception of a status report or a prior retransmission (e.g., autonomous, or conventional retransmissions and status reports) of a data packet. In some examples, at 402, an RLC transmitting entity receives a status report including a NACK for one or more RLC data packets (e.g., PDUs and/or SDUs). The RLC transmitting entity may receive the status report prior to a threshold for enhanced polling for the one or more RLC data packets is satisfied at 404. Additionally, or alternatively, the RLC transmitting entity may receive the status report prior to a threshold for autonomous retransmission for the one or more RLC data packets is satisfied at 406. Thus, at 406, the RLC transmitting entity may cancel one or more autonomous retransmissions of the data packets. If the RLC transmitting entity receives a NACK in the status report at 402, then the RLC transmitting entity triggers a retransmission of the data packet. Thus, the autonomous retransmissions are redundant to the retransmission of the data packet, and the RLC transmitting entity may cancel the one or more autonomous retransmissions.

In some cases, the RLC transmitting entity may receive an additional time threshold that indicates a minimum time gap between a retransmission and an autonomous retransmission of a same data packet. That is, if a retransmission is triggered and/or submitted by the RLC transmitting entity (e.g., based on the reception of a status report), then the RLC transmitting entity may cancel one or more autonomous retransmissions of the same data packet unless the previous retransmission was submitted at least the additional time threshold prior to an autonomous retransmission.

In some other cases, the RLC transmitting entity may be configured to cancel the autonomous retransmission based on an importance value of the data packets. For example, a NE may configure the RLC transmitting entity to cancel the autonomous retransmissions for data packets with an importance value that fails to satisfy (e.g., is below) a threshold value. The NE may configure the RLC transmitting entity to transmit the autonomous retransmissions for data packets with an importance value that satisfies (e.g., is above) the threshold value. The importance value of a data packet may be based on a packet system information (PSI) value.

FIG. 5 illustrates an example transmission diagram 500 in accordance with aspects of the present disclosure. In some examples, the transmission diagram 500 implements or is implemented by aspects of the wireless communications system 100, the transmission diagram 200, the transmission diagram 300, and the transmission diagram 400. For example, the transmission diagram 500 may be implemented by a transmitting device, which may be an example of a NE 102 and/or a UE 104 as described with reference to FIG. 1. The transmission diagram 500 illustrates an example of canceling (e.g., not performing, disabling) enhanced polling and canceling (e.g., disabling, not transmitting) one or more autonomous retransmissions according to conditions being met (e.g., satisfied).

In some examples, at 502, an RLC transmitting entity receives a status report that includes a NACK for one or more RLC data packets (e.g., PDUs and/or SDUs). The RLC transmitting entity may receive the status report prior to a threshold for enhanced polling for the RLC data packets and a threshold for autonomous retransmissions for the RLC data packets are reached at 504 and at 506, respectively. If the RLC transmitting entity receives the status report including the NACK for the RLC data packets prior to the threshold for enhanced polling for the RLC data packets, then, at 504, the RLC transmitting entity may cancel enhanced polling for the RLC data packets. Additionally, or alternatively, if the RLC transmitting entity receives the status report including the NACK for the RLC data packets prior to the threshold for autonomous retransmissions for the RLC data packets, then, at 506, the RLC transmitting entity may cancel the autonomous retransmissions of the RLC data packet. If the RLC transmitting entity receives a NACK for one or more data packets in the status report, then the RLC transmitting entity triggers a retransmission of the data packets. Thus, the autonomous retransmissions would be redundant to the retransmissions. Furthermore, the enhanced polling may not provide accurate information of the data packet status if performed before the RLC receiving entity has a chance to receive the retransmitted data packets.

In some cases, the RLC transmitting entity may cancel the enhanced polling and/or autonomous retransmission based on an additional time threshold. The additional time threshold may indicate a minimum time gap between a retransmission and the enhanced polling or autonomous retransmissions of a same data packet. The time threshold may be separately configured for enhanced polling and autonomous retransmission (e.g., may not be a same value) and/or may be a same value for the enhanced polling and autonomous retransmission.

In some other cases, the RLC transmitting entity may be configured to cancel the enhanced polling and/or autonomous retransmission based on an importance value of the packets. For example, a NE may configure the RLC transmitting entity to cancel the enhanced polling and/or autonomous retransmissions for data packets with an importance value that fails to satisfy (e.g., is below) a threshold value. The NE may configure the RLC transmitting entity to transmit the autonomous retransmissions and/or perform the enhanced polling for data packets with an importance value that satisfies (e.g., is above) the threshold value. The importance value of a data packet may be based on a PSI value. The importance value criteria may be separately configured for enhanced polling and autonomous retransmission (e.g., may not be a same value) and/or may be a same value for the enhanced polling and autonomous retransmission.

FIG. 6 illustrates an example transmission diagram 600 in accordance with aspects of the present disclosure. In some examples, the transmission diagram 600 implements or is implemented by aspects of the wireless communications system 100, the transmission diagram 200, the transmission diagram 300, the transmission diagram 400, and the transmission diagram 500. For example, the transmission diagram 600 may be implemented by a transmitting device, which may be an example of a NE 102 and/or a UE 104 as described with reference to FIG. 1. The transmission diagram 600 illustrates an example of canceling (e.g., disabling, not transmitting) one or more autonomous retransmissions according to conditions being met (e.g., satisfied).

At 602, an RLC transmitting entity may perform enhanced polling based on a polling enhancement threshold being met. In some examples, at 604, the RLC transmitting entity may receive a status report (e.g., in response to the enhanced polling). The status report may include a NACK for one or more RLC data packets (e.g., RLC SDUs and/or PDUs) that triggered the enhanced poll-bit. The RLC transmitting entity may retransmit the RLC data packets upon receiving the status report at 604. At 606, the RLC transmitting entity may cancel the autonomous retransmission (e.g., to avoid increasing signaling overhead at the RLC layer).

In some examples, the RLC transmitting entity may be configured with an additional time threshold that indicates a minimum time gap between a retransmission triggered by the status report and an autonomous retransmission of a same data packet. That is, if a retransmission is triggered or submitted by the RLC transmitting entity, then the RLC transmitting entity cancels the autonomous retransmission for the same data packet unless the previous retransmission was submitted at least the additional time threshold prior to the autonomous retransmission.

In some other examples, the RLC transmitting entity may be configured to cancel the autonomous retransmission based on an importance value of the packets. For example, a NE may configure the RLC transmitting entity to cancel the autonomous retransmissions for data packets with an importance value that fails to satisfy (e.g., is below) a threshold value. The NE may configure the RLC transmitting entity to transmit the autonomous retransmissions for data packets with an importance value that satisfies (e.g., is above) the threshold value. The importance value of a data packet may be based on a PSI value.

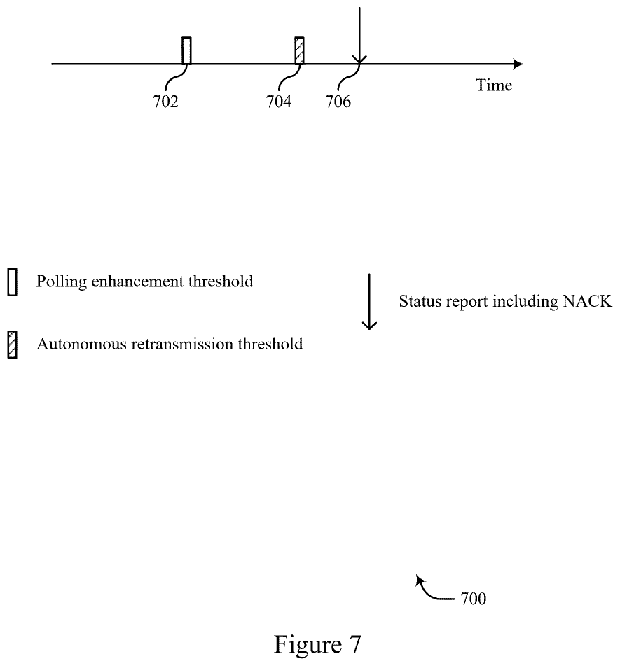

FIG. 7 illustrates an example transmission diagram 700 in accordance with aspects of the present disclosure. In some examples, the transmission diagram 700 implements or is implemented by aspects of the wireless communications system 100, the transmission diagram 200, the transmission diagram 300, the transmission diagram 400, the transmission diagram 500, and the transmission diagram 600. For example, the transmission diagram 700 may be implemented by a transmitting device, which may be an example of a NE 102 and/or a UE 104 as described with reference to FIG. 1. The transmission diagram 600 illustrates an example of enabling (e.g., performing, activating) enhanced polling and transmitting (e.g., enabling transmission of) one or more autonomous retransmissions according to conditions being met (e.g., satisfied).

In some examples, at 702, an RLC transmitting entity may perform enhanced polling for one or more RLC data packets (e.g., RLC PDUs and/or SDUs) based on a polling enhancement threshold being met prior to the RLC transmitting entity receiving a status report for the RLC data packets. Additionally, or alternatively, at 704, the RLC transmitting entity may perform one or more autonomous retransmissions of the RLC data packets based on an autonomous retransmission threshold being met prior to the RLC transmitting entity receiving the status report.

At 706, the RLC transmitting entity may receive a status report including a NACK of the RLC data packets. If the RLC transmitting entity receives that status report that includes the NACK for the RLC data packets for which the RLC transmitting entity has submitted or performed an enhanced poll and/or an autonomous retransmission, then the RLC transmitting entity may not perform further retransmissions of the RLC data packets (e.g., neither retransmissions triggered by the NACK nor autonomous retransmissions). That is, as the RLC data packets are autonomously retransmitted when the remaining time of the RLC data packet is relatively small (e.g., less than a threshold value), further retransmission of the RLC data packets upon reception of a NACK may not be useful for an RLC receiving entity. For example, a remaining time of the data packets (e.g., based on a discardTimer or discardTimerForLowImportance timer) may have expired or may expire before reception of the RLC data packets.

The RLC transmitting entity may maintain an awareness of the data packets that are autonomously retransmitted to cancel any further retransmissions. In some examples, the RLC transmitting entity may proactively discard the RLC data packets (e.g., PDUs) that are autonomously retransmitted regardless of whether an ACK is received for the RLC data packets. The RLC transmitting entity may perform the transmission window update, as described with respect to FIGS. 2 and 3 (e.g., based on the reception of a status report). If the RLC transmitting entity receives a NACK for the autonomously retransmitted data packets, then the RLC transmitting entity may ignore (e.g., disregard) the NACK and may update a transmission window irrespective of (e.g., independent of, without considering) the received NACK. The RLC receiving entity may update a reception window for the RLC data packets using a local timer (e.g., for abandonment of RLC SDUs in the RLC receiving entity) and/or the RLC transmitting entity may transmit signaling to the RLC receiving entity that indicates a window update. The signaling may include a control data packet (e.g., PDU).

Additionally, or alternatively, the RLC transmitting entity may include a flag within an autonomous retransmission, such that upon reception of an RLC data packet (e.g., RLC PDU) with the flag enabled, the RLC receiving entity may not expect further retransmissions of the same data packet or segments of that data packet. The RLC receiving entity may update a reception window in accordance with the flag bit. The RLC receiving entity may transmit a status report indicating an ACK or a dummy ACK for the corresponding RLC data packet and/or segments of the RLC data packet. The RLC transmitting entity may update a transmission window based on the status report, as described with reference to FIGS. 2 and 3.

In some examples, upon reception of a NACK for an RLC data packet that the RLC transmitting entity previously autonomously retransmitted, the RLC transmitting entity may inform the RLC receiving entity (e.g., by means of a control data packet) that the same RLC data packet may not be retransmitted. The RLC transmitting entity may discard the RLC data packet and update a transmission window, accordingly. The RLC receiving entity may also update a reception window in accordance with the control data packet.

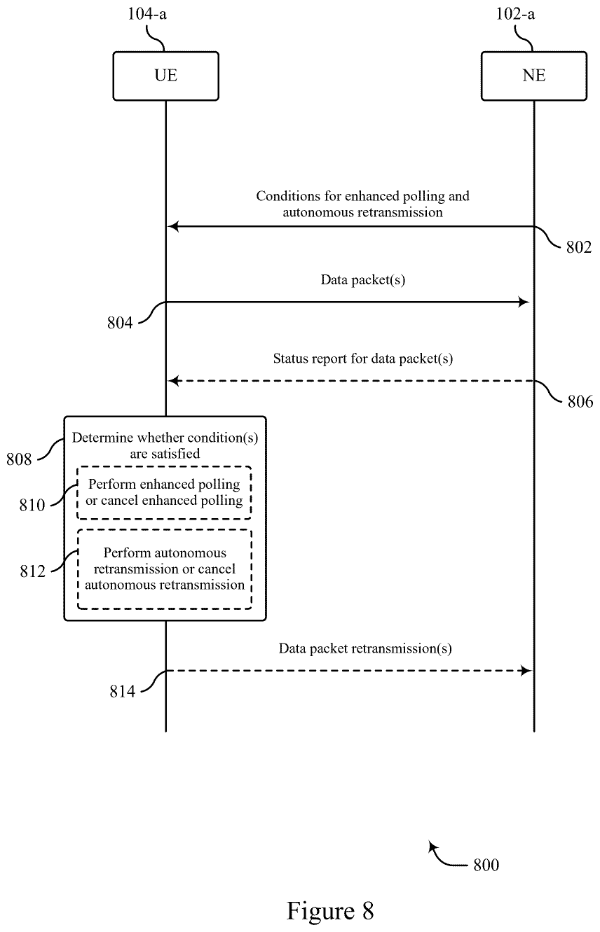

FIG. 8 illustrates an example signaling diagram 800 in accordance with aspects of the present disclosure. In some examples, the signaling diagram 800 implements or is implemented by aspects of the wireless communications system 100, the transmission diagram 200, the transmission diagram 300, the transmission diagram 400, the transmission diagram 500, the transmission diagram 600, and the transmission diagram 700. The signaling diagram 800 may implement or be implemented by a UE 104-a and a NE 102-a, which may be examples of the corresponding devices as described with reference to FIG. 1. For example, the NE 102-a may provide the UE 104-a with one or more conditions for dynamically performing enhanced polling and/or autonomous retransmissions. Alternative examples of the following may be implemented, where some processes are performed in a different order than described or are not performed. In some cases, processes may include additional features not mentioned below, or further processes may be added.

In some examples, the processes described as being performed by the UE 104-a may additionally, or alternatively, be performed by an RLC transmitting entity (e.g., implemented by a UE or by another device). The processes described as being performed by the NE 102-a may additionally, or alternatively, be performed by an RLC receiving entity (e.g., implemented by a NE or by another device).

At 802, the NE 102-a transmits signaling to the UE 104-a that includes conditions for enhanced polling and autonomous retransmissions for RLC data packets (e.g., PDUs and/or SDUs). For example, the singling includes conditions that indicate for the UE 104-a to enable (e.g., activate, perform) or canceling (e.g., disable, deactivate, cancel, not perform) inclusion of a poll bit in a header of a data packet at an RLC layer of the UE 104-a or for the UE 104-a to cancel (e.g., disable, not transmit) one or more retransmissions (e.g., autonomous retransmissions or other retransmissions) of the data packet at the RLC layer of the UE 104-a. The signaling may include RRC signaling. The set of conditions may be configured in at least one of a PDCP IE or an RLC IE. The PDCP IE may include an autonomous retransmission timer parameter or an enhanced polling timer parameter. The RLC IE may include an autonomous retransmission threshold parameter or a delay critical poll parameter.

The set of conditions may include at least one of a first threshold duration for enabling the inclusion of the poll bit in the header of the data packet at the RLC layer of the UE 104-a, a second threshold duration for transmitting the one or more retransmissions of the data packet at the RLC layer of the UE 104-a, a third threshold duration for canceling the one or more retransmissions of the data packet at the RLC layer of the UE 104-a, a fourth threshold duration for canceling the inclusion of the poll bit in the header of the data packet at the RLC layer of the UE 104-a, or a threshold importance value of the data packet. In some cases, the first threshold duration may be offset from the second threshold duration according to a minimum time for receiving a status report after transmitting the data packet that includes the poll bit. Additionally, or alternatively, the second threshold duration may be based on a minimum time for receiving the data packet at the RLC layer of the UE 104-a. The third threshold duration may be based on a minimum time between a retransmission of the data packet and an autonomous retransmission of the data packet. The fourth threshold duration may be based on a minimum time between a retransmission of the data packet and a transmission of the data packet including the poll bit in the header of the data packet. In some cases, the first threshold duration may be a same value as the second threshold duration.

At 804, the UE 104-a transmits one or more data packets to the NE 102-a. In some cases, at 806, the NE 102-a transmits a status report for the data packets to the UE 104-a. At 808, the UE 104-a determines whether one or more conditions are satisfied (e.g., met). The UE 104-a may use the determination of whether the conditions are satisfied to manage enhanced polling and to manage autonomous retransmissions. For example, the UE 104-a determines whether one or more first conditions for enabling or canceling enhanced polling are satisfied. Based on this determination, at 810, the UE 104-a enables or cancels enhanced polling. In some other examples, the UE 104-a determines whether one or more second conditions for transmitting autonomous retransmission or canceling the autonomous retransmissions are met. Based on this determination, at 812, the UE 104-a determines whether to perform autonomous retransmission or cancel autonomous retransmission.

In some cases, the UE 104-a may enable the inclusion of the poll bit in the header of the data packet and receive, responsive to the poll bit, the status report. The status report may include at least one of an ACK confirming the data packets are received successfully or NACK indicating the data packets are not received successfully. Additionally, or alternatively, the UE 104-a may cancel the one or more retransmissions of the data packet at the RLC layer of the UE 104-a responsive to receiving a status report including a NACK that triggers a retransmission of the data packets (e.g., to reduce redundant retransmissions of the data packets). At least one of the one or more first conditions or the one or more second conditions may be satisfied if the status report includes the NACK for the data packets.

In some examples, the UE 104 may transmit, independent of the status report, one or more retransmissions of one or more data packets (e.g., autonomous retransmissions or other retransmissions). After the one or more retransmissions of the data packets, the UE 104 may receive the status report, where the status report includes a NACK for the data packets. The one or more second conditions may include the status report including the NACK. The UE 104-a may discard the data packets after the one or more retransmissions of the data packets and independent of the status report corresponding to the data packets. The UE 104-a may update a transmission window for the data packets. The UE 104-a may receive the status report at 806, and the status report may include a NACK for the retransmissions of the data packets. The UE 104-a may update a transmission window for the data packet independent of the NACK. The NE 102-a may update a reception window using a local timer, a first control data packet that indicates the reception window, a flag in the retransmissions of the data packet that indicates autonomous retransmissions of the data packet are canceled, or a second control data packet that indicates autonomous retransmissions of the data packet are canceled, among other examples.

In some examples, at 814, the UE 104-a sends one or more data packet retransmissions to the NE 102-a. For example, the UE 104-a may perform a retransmission upon receiving a status report and/or may perform one or more autonomous retransmissions if the autonomous retransmissions are not canceled (e.g., conditions for canceling the autonomous retransmissions are not satisfied or met). The NE 102-a may receive the data packets and/or the retransmissions of the data packets.

FIG. 9 illustrates an example of a configuration 900 in accordance with aspects of the present disclosure. In some examples, the configuration 900 implements or is implemented by aspects of the wireless communications system 100, the transmission diagram 200, the transmission diagram 300, the transmission diagram 400, the transmission diagram 500, the transmission diagram 600, the transmission diagram 700, and the signaling diagram 800. For example, the configuration 900 may be implemented by a NE 102 and/or a UE 104, which may be examples of the corresponding devices as described with reference to FIG. 1. The NE may transmit signaling (e.g., control signaling) including the configuration 900.

In some examples, a NE may include the timers for the enhanced polling threshold and autonomous retransmission threshold in a PDCP IE (e.g., PDCP-Config IE) via RRC signaling. For example, the enhanced polling may be configured as a new parameter (e.g., EnhancedPollingTimer) and autonomous retransmission may be configured as a new parameter (e.g., AutonomousRetxTimer). The EnhancedPollingTimer parameter and/or the AutonomousRetxTimer may include a value in ms that indicates when a UE or other RLC transmitting entity is to perform enhanced polling and/or autonomous retransmission. That is, if the duration specified by the parameters expires, then the UE may trigger enhanced polling and/or autonomous retransmission, accordingly.

FIG. 10 illustrates an example of a configuration 1000 in accordance with aspects of the present disclosure. In some examples, the configuration 1000 implements or is implemented by aspects of the wireless communications system 100, the transmission diagram 200, the transmission diagram 300, the transmission diagram 400, the transmission diagram 500, the transmission diagram 600, the transmission diagram 700, the signaling diagram 800, and the configuration 900. For example, the configuration 1000 may be implemented by a NE 102 and/or a UE 104, which may be examples of the corresponding devices as described with reference to FIG. 1. The NE may transmit signaling (e.g., control signaling) including the configuration 1000.

In some examples, a NE may include an additional parameter (e.g., delayCriticalPoll) in an RLC IE (e.g., an RLC-Config IE) to point to a remaining time value for when the UE is to include a poll-bit. Additionally, or alternatively, the NE may include an additional parameter (e.g., T-RemainingTimePoll) in the RLC IE to indicate one or more different remaining time threshold values that trigger the enhanced polling. The T-RemainingTimePoll parameter may include a value in ms that indicates when a UE or other RLC transmitting entity is to perform enhanced polling. That is, if the duration specified by the T-RemainingTimePoll parameter expires, then the UE may trigger enhanced polling.

FIG. 11 illustrates an example of a configuration 1100 in accordance with aspects of the present disclosure. In some examples, the configuration 1100 implements or is implemented by aspects of the wireless communications system 100, the transmission diagram 200, the transmission diagram 300, the transmission diagram 400, the transmission diagram 500, the transmission diagram 600, the transmission diagram 700, the signaling diagram 800, the configuration 900, and the configuration 1000. For example, the configuration 1100 may be implemented by a NE 102 and/or a UE 104, which may be examples of the corresponding devices as described with reference to FIG. 1. The NE may transmit signaling (e.g., control signaling) including the configuration 1100.

In some examples, a NE may include an additional parameter in an RLC IE (e.g., autonomousRetxThreshold) to indicate a remaining time value for when the UE is to transmit an autonomous retransmission for a data packet and an additional parameter (e.g., T-RemainingTimeAR) to indicate one or more different remaining time threshold values for triggering autonomous retransmissions. The T-RemainingTimeAR parameter may include a value in ms that indicates when a UE or other RLC transmitting entity is to perform autonomous retransmissions. That is, if the duration specified by the T-RemainingTimeAR parameter expires, then the UE may trigger an autonomous retransmission of one or more data packets.

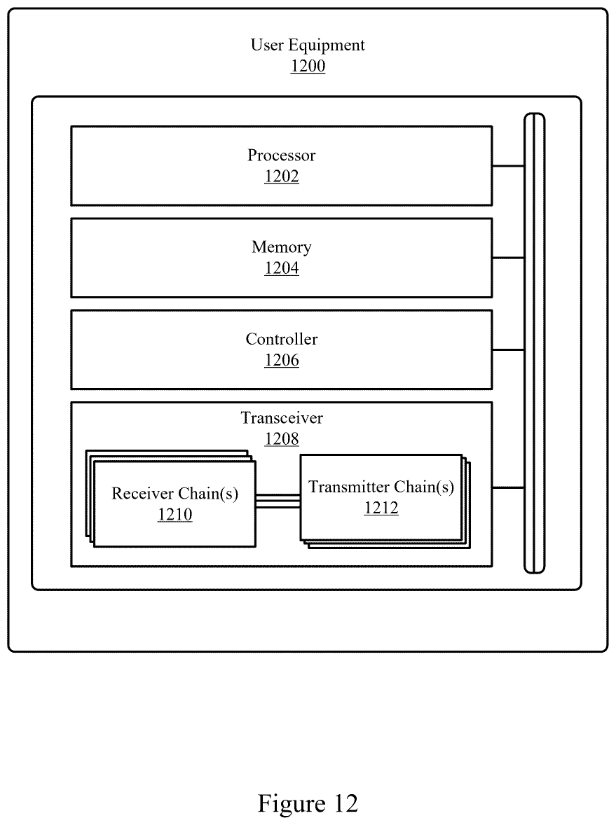

FIG. 12 illustrates an example of a UE 1200 in accordance with aspects of the present disclosure. The UE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the UE 1200 to perform various functions of the present disclosure.

The memory 1204 may include volatile or non-volatile memory. The memory 1204 may store computer-readable, computer-executable code including instructions when executed by the processor 1202 cause the UE 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the UE 1200 to perform one or more of the functions described herein (e.g., executing, by the processor 1202, instructions stored in the memory 1204). For example, the processor 1202 may support wireless communication at the UE 1200 in accordance with examples as disclosed herein. The UE 1200 may be configured to or operable to support a means for receiving signaling that indicates a plurality of conditions associated with at least one of the UE managing (e.g., enabling or canceling) inclusion of a poll bit in a header of a data packet at an RLC layer of the UE or the UE managing (e.g., transmitting or canceling) one or more retransmissions of the data packet at the RLC layer of the UE, managing (e.g., enabling or canceling), based on one or more first conditions of the plurality of conditions being satisfied, the inclusion of the poll bit in the header of the data packet at the RLC layer of the UE, and canceling, based on one or more second conditions of the plurality of conditions being satisfied, the one or more retransmissions of the data packet at the RLC layer of the UE, where the one or more second conditions of the plurality of conditions are satisfied based on a status report corresponding to the data packet.

Additionally, the UE 1200 may be configured to support any one or combination of the plurality of conditions includes at least one of a first threshold duration corresponding to including the poll bit in the header of the data packet at the RLC layer of the UE, a second threshold duration corresponding to transmitting the one or more retransmissions of the data packet at the RLC layer of the UE, a third threshold duration corresponding to canceling the one or more retransmissions of the data packet at the RLC layer of the UE, a fourth threshold duration corresponding to canceling the inclusion of the poll bit in the header of the data packet at the RLC layer of the UE, or a threshold importance value of the data packet. Additionally, or alternatively, the UE 1200 may be configured to support one or more of: the first threshold duration is offset from the second threshold duration based on a minimum time associated with receiving the status report after transmitting the data packet including the poll bit; the second threshold duration is based on a minimum time associated with receiving the data packet at the RLC layer of the UE; the third threshold duration is based on a minimum time between a retransmission of the data packet and the one or more retransmissions of the data packet; or the fourth threshold duration is based on a minimum time between a retransmission of the data packet and a transmission of the data packet including the poll bit in the header of the data packet. Additionally, or alternatively, the UE 1200 may be configured to support the first threshold duration is a same value as the second threshold duration. Additionally, or alternatively, the UE 1200 may be configured to support the signaling includes RRC signaling, where the set of conditions are configured in at least one of a PDCP IE or an RLC IE, and where one or more of the PDCP IE includes an autonomous retransmission timer parameter, the PDCP IE includes an enhanced polling timer parameter, the RLC IE includes an autonomous retransmission threshold parameter, or the RLC IE includes a delay critical poll parameter.

Additionally, or alternatively, to cancel the one or more retransmissions of the data packet at the RLC layer of the UE, the UE 1200 may be configured to support means for receiving the status report, where the status report includes a NACK corresponding to the data packet, where at least one of the one or more first conditions or the one or more second conditions are satisfied based on the status report including the NACK corresponding to the data packet, and where the NACK triggers a retransmission of the data packet. Additionally, or alternatively, to manage the inclusion of the poll bit in the header of the data packet, the UE 1200 may be configured to or operable to support a means for including the poll bit in the header of the data packet, and receiving, responsive to the poll bit, the status report, where the status report includes at least one of an ACK or NACK corresponding to the data packet. Additionally, or alternatively, to cancel the one or more retransmissions of the data packet at the RLC layer of the UE, the UE 1200 may be configured to or operable to support a means for retransmitting the data packet based on the status report including the NACK, where the one or more second conditions include the status report including the NACK. Additionally, or alternatively, the UE 1200 may be configured to or operable to support a means for transmitting, independent of the status report, one or more additional retransmissions of the data packet.

Additionally, or alternatively, to manage the inclusion of the poll bit in the header of the data packet, the UE 1200 may be configured to or operable to support a means for receiving, after the one or more retransmissions of the data packet, the status report, where the status report includes a NACK corresponding to the data packet, and where the one or more second conditions include the status report including the NACK and canceling, based on the status report, the one or more additional retransmissions of the data packet at the RLC layer of the UE. Additionally, or alternatively, the UE 1200 may be configured to or operable to support a means for discarding, after the one or more additional retransmissions of the data packet and independent of the status report corresponding to the data packet, the data packet, and updating a transmission window associated with the data packet. Additionally, or alternatively, the UE 1200 may be configured to or operable to support a means for receiving the status report, where the status report includes a NACK corresponding to the one or more additional retransmissions of the data packet, and update, independent of the NACK, a transmission window associated with the data packet, where a reception window is based on at least one of a local timer, a first control data packet that indicates the reception window, a flag in the one or more additional retransmissions of the data packet that indicates the one or more retransmissions of the data packet are canceled, or a second control data packet that indicates the one or more retransmissions of the data packet are canceled.

Additionally, or alternatively, the UE 1200 may support at least one memory (e.g., the memory 1204) and at least one processor (e.g., the processor 1202) coupled with the at least one memory and configured to cause the UE to receive signaling that indicates a set of conditions associated with at least one of the UE managing (e.g., enabling or canceling) inclusion of a poll bit in a header of a data packet at an RLC layer of the UE or the UE managing (e.g., transmitting or canceling) one or more retransmissions of the data packet at the RLC layer of the UE, manage (e.g., enable or cancel), based on one or more first conditions of the set of conditions being satisfied, the inclusion of the poll bit in the header of the data packet at the RLC layer of the UE, and cancel, based on one or more second conditions of the set of conditions being satisfied, the one or more retransmissions of the data packet at the RLC layer of the UE, where the one or more second conditions of the set of conditions are satisfied based on a status report corresponding to the data packet.

Additionally, the UE 1200 may be configured to support any one or combination of the set of conditions includes at least one of a first threshold duration corresponding to including the poll bit in the header of the data packet at the RLC layer of the UE, a second threshold duration corresponding to transmitting the one or more retransmissions of the data packet at the RLC layer of the UE, a third threshold duration corresponding to canceling the one or more retransmissions of the data packet at the RLC layer of the UE, a fourth threshold duration corresponding to canceling the inclusion of the poll bit in the header of the data packet at the RLC layer of the UE, or a threshold importance value of the data packet. Additionally, or alternatively, the UE 1200 may be configured to support one or more of: the first threshold duration is offset from the second threshold duration based on a minimum time associated with receiving the status report after transmitting the data packet including the poll bit; the second threshold duration is based on a minimum time associated with receiving the data packet at the RLC layer of the UE; the third threshold duration is based on a minimum time between a retransmission of the data packet and the one or more retransmissions of the data packet; or the fourth threshold duration is based on a minimum time between a retransmission of the data packet and a transmission of the data packet including the poll bit in the header of the data packet. Additionally, or alternatively, the UE 1200 may be configured to support the first threshold duration is a same value as the second threshold duration. Additionally, or alternatively, the UE 1200 may be configured to support the signaling includes RRC signaling, where the set of conditions are configured in at least one of a PDCP IE or an RLC IE, and where one or more of the PDCP IE includes an autonomous retransmission timer parameter, the PDCP IE includes an enhanced polling timer parameter, the RLC IE includes an autonomous retransmission threshold parameter, or the RLC IE includes a delay critical poll parameter.

Additionally, or alternatively, to cancel the one or more retransmissions of the data packet at the RLC layer of the UE, the UE 1200 may be configured to support to receive the status report, where the status report includes a NACK corresponding to the data packet, where at least one of the one or more first conditions or the one or more second conditions are satisfied based on the status report including the NACK corresponding to the data packet, and where the NACK triggers a retransmission of the data packet. Additionally, or alternatively, to manage the inclusion of the poll bit in the header of the data packet, the UE 1200 may be configured to support to include the poll bit in the header of the data packet, and receive, responsive to the poll bit, the status report, where the status report includes at least one of an ACK or NACK corresponding to the data packet. Additionally, or alternatively, to cancel the one or more retransmissions of the data packet at the RLC layer of the UE, the UE 1200 may be configured to support to retransmit the data packet based on the status report including the NACK, where the one or more second conditions include the status report including the NACK.

Additionally, or alternatively, the UE 1200 may be configured to support to transmit, independent of the status report, one or more additional retransmissions of the data packet. Additionally, or alternatively, to manage the inclusion of the poll bit in the header of the data packet, the UE 1200 may be configured to support to receive, after the one or more retransmissions of the data packet, the status report, where the status report includes a NACK corresponding to the data packet, and where the one or more second conditions include the status report including the NACK, and cancel, based on the status report, the one or more additional retransmissions of the data packet at the RLC layer of the UE. Additionally, or alternatively, the UE 1200 may be configured to support to discard, after the one or more additional retransmissions of the data packet and independent of the status report corresponding to the data packet, the data packet, and update a transmission window associated with the data packet. Additionally, or alternatively, the UE 1200 may be configured to support to receive the status report, where the status report includes a NACK corresponding to the one or more additional retransmissions of the data packet, and update, independent of the NACK, a transmission window associated with the data packet, where a reception window is based on at least one of a local timer, a first control data packet that indicates the reception window, a flag in the one or more additional retransmissions of the data packet that indicates the one or more retransmissions of the data packet are canceled, or a second control data packet that indicates the one or more retransmissions of the data packet are canceled.

The controller 1206 may manage input and output signals for the UE 1200. The controller 1206 may also manage peripherals not integrated into the UE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the UE 1200 may include at least one transceiver 1208. In some other implementations, the UE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

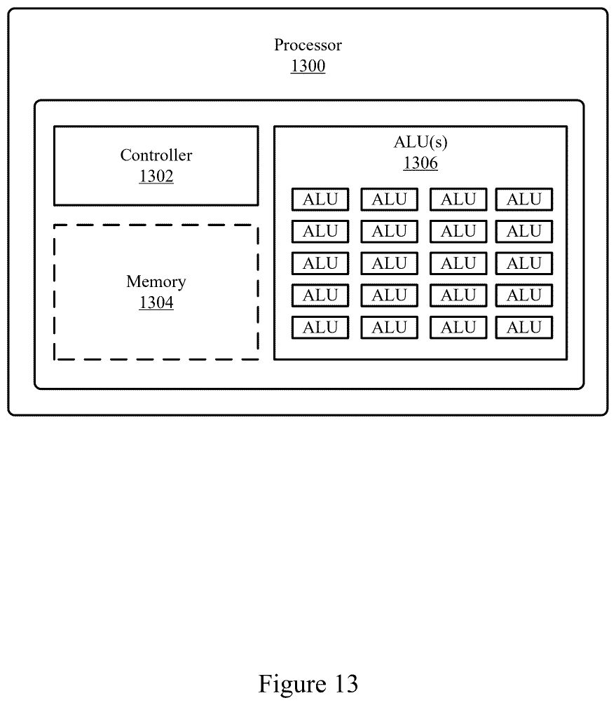

FIG. 13 illustrates an example of a processor 1300 in accordance with aspects of the present disclosure. The processor 1300 may be an example of a processor configured to perform various operations in accordance with examples as described herein. The processor 1300 may include a controller 1302 configured to perform various operations in accordance with examples as described herein. The processor 1300 may optionally include at least one memory 1304, which may be, for example, an L1/L2/L3 cache. Additionally, or alternatively, the processor 1300 may optionally include one or more arithmetic-logic units (ALUs) 1306. One or more of these components may be in electronic communication or otherwise coupled (e.g., operatively, communicatively, functionally, electronically, electrically) via one or more interfaces (e.g., buses).

The processor 1300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1302 may be configured to manage and coordinate various operations (e.g., signaling, receiving, obtaining, retrieving, transmitting, outputting, forwarding, storing, determining, identifying, accessing, writing, reading) of the processor 1300 to cause the processor 1300 to support various operations in accordance with examples as described herein. For example, the controller 1302 may operate as a control unit of the processor 1300, generating control signals that manage the operation of various components of the processor 1300. These control signals include enabling or disabling functional units, selecting data paths, initiating memory access, and coordinating timing of operations.

The controller 1302 may be configured to fetch (e.g., obtain, retrieve, receive) instructions from the memory 1304 and determine subsequent instruction(s) to be executed to cause the processor 1300 to support various operations in accordance with examples as described herein. The controller 1302 may be configured to track memory addresses of instructions associated with the memory 1304. The controller 1302 may be configured to decode instructions to determine the operation to be performed and the operands involved. For example, the controller 1302 may be configured to interpret the instruction and determine control signals to be output to other components of the processor 1300 to cause the processor 1300 to support various operations in accordance with examples as described herein. Additionally, or alternatively, the controller 1302 may be configured to manage flow of data within the processor 1300. The controller 1302 may be configured to control transfer of data between registers, ALUs 1306, and other functional units of the processor 1300.

The memory 1304 may include one or more caches (e.g., memory local to or included in the processor 1300 or other memory, such as RAM, ROM, DRAM, SDRAM, SRAM, MRAM, flash memory, etc. In some implementations, the memory 1304 may reside within or on a processor chipset (e.g., local to the processor 1300). In some other implementations, the memory 1304 may reside external to the processor chipset (e.g., remote to the processor 1300).

The memory 1304 may store computer-readable, computer-executable code including instructions that, when executed by the processor 1300, cause the processor 1300 to perform various functions described herein. The code may be stored in a non-transitory computer-readable medium such as system memory or another type of memory. The controller 1302 and/or the processor 1300 may be configured to execute computer-readable instructions stored in the memory 1304 to cause the processor 1300 to perform various functions. For example, the processor 1300 and/or the controller 1302 may be coupled with or to the memory 1304, the processor 1300, and the controller 1302, and may be configured to perform various functions described herein. In some examples, the processor 1300 may include multiple processors and the memory 1304 may include multiple memories. One or more of the multiple processors may be coupled with one or more of the multiple memories, which may, individually or collectively, be configured to perform various functions herein.

The one or more ALUs 1306 may be configured to support various operations in accordance with examples as described herein. In some implementations, the one or more ALUs 1306 may reside within or on a processor chipset (e.g., the processor 1300). In some other implementations, the one or more ALUs 1306 may reside external to the processor chipset (e.g., the processor 1300). One or more ALUs 1306 may perform one or more computations such as addition, subtraction, multiplication, and division on data. For example, one or more ALUs 1306 may receive input operands and an operation code, which determines an operation to be executed. One or more ALUs 1306 may be configured with a variety of logical and arithmetic circuits, including adders, subtractors, shifters, and logic gates, to process and manipulate the data according to the operation. Additionally, or alternatively, the one or more ALUs 1306 may support logical operations such as AND, OR, exclusive-OR (XOR), not-OR (NOR), and not-AND (NAND), enabling the one or more ALUs 1306 to handle conditional operations, comparisons, and bitwise operations.

The processor 1300 may support wireless communication in accordance with examples as disclosed herein. The processor 1300 may be configured to or operable to support at least one controller (e.g., the controller 1302) coupled with at least one memory (e.g., the memory 1304) and configured to cause the processor to receive signaling that indicates a set of conditions associated with at least one of the processor managing (e.g., enabling or canceling) inclusion of a poll bit in a header of a data packet at an RLC layer of the processor or the processor managing (e.g., canceling) one or more retransmissions of the data packet at the RLC layer of the processor, manage (e.g., enable or cancel), based on one or more first conditions of the set of conditions being satisfied, the inclusion of the poll bit in the header of the data packet at the RLC layer of the processor, and cancel, based on one or more second conditions of the set of conditions being satisfied, the one or more retransmissions of the data packet at the RLC layer of the processor, where the one or more second conditions of the set of conditions are satisfied based on a status report corresponding to the data packet.

Additionally, the processor 1300 may be configured to support any one or combination of the set of conditions includes at least one of a first threshold duration corresponding to including the poll bit in the header of the data packet at the RLC layer of the processor, a second threshold duration corresponding to transmitting the one or more retransmissions of the data packet at the RLC layer of the processor, a third threshold duration corresponding to canceling the one or more retransmissions of the data packet at the RLC layer of the processor, a fourth threshold duration corresponding to canceling the inclusion of the poll bit in the header of the data packet at the RLC layer of the processor, or a threshold importance value of the data packet. Additionally, or alternatively, the processor 1300 may be configured to support one or more of: the first threshold duration is offset from the second threshold duration based on a minimum time associated with receiving the status report after transmitting the data packet including the poll bit; the second threshold duration is based on a minimum time associated with receiving the data packet at the RLC layer of the processor; the third threshold duration is based on a minimum time between a retransmission of the data packet and the one or more retransmissions of the data packet; or the fourth threshold duration is based on a minimum time between a retransmission of the data packet and a transmission of the data packet including the poll bit in the header of the data packet. Additionally, or alternatively, the processor 1300 may be configured to support the first threshold duration is a same value as the second threshold duration. Additionally, or alternatively, the processor 1300 may be configured to support the signaling includes RRC signaling, where the set of conditions are configured in at least one of a PDCP IE or an RLC IE, and where one or more of the PDCP IE includes an autonomous retransmission timer parameter, the PDCP IE includes an enhanced polling timer parameter, the RLC IE includes an autonomous retransmission threshold parameter, or the RLC IE includes a delay critical poll parameter.

Additionally, or alternatively, to cancel the one or more retransmissions of the data packet at the RLC layer of the processor, the processor 1300 may be configured to support to receive the status report, where the status report includes a NACK corresponding to the data packet, where at least one of the one or more first conditions or the one or more second conditions are satisfied based on the status report including the NACK corresponding to the data packet, and where the NACK triggers a retransmission of the data packet. Additionally, or alternatively, to manage the inclusion of the poll bit in the header of the data packet, the processor 1300 may be configured to support to include the poll bit in the header of the data packet, and receive, responsive to the poll bit, the status report, where the status report includes at least one of an ACK or NACK corresponding to the data packet. Additionally, or alternatively, the processor 1300 may be configured to support to retransmit the data packet based on the status report including the NACK, where the one or more second conditions include the status report including the NACK.

Additionally, or alternatively, the processor 1300 may be configured to support to transmit, independent of the status report, one or more additional retransmissions of the data packet. Additionally, or alternatively, to manage the inclusion of the poll bit in the header of the data packet, the processor 1300 may be configured to support to receive, after the one or more retransmissions of the data packet, the status report, where the status report includes a NACK corresponding to the data packet, and where the one or more second conditions include the status report including the NACK, and cancel, based on the status report, the one or more additional retransmissions of the data packet at the RLC layer of the processor 1300. Additionally, or alternatively, the processor 1300 may be configured to support to discard, after the one or more additional retransmissions of the data packet and independent of the status report corresponding to the data packet, the data packet, and update a transmission window associated with the data packet. Additionally, or alternatively, the processor 1300 may be configured to support to receive the status report, where the status report includes a NACK corresponding to the one or more additional retransmissions of the data packet, and update, independent of the NACK, a transmission window associated with the data packet, where a reception window is based on at least one of a local timer, a first control data packet that indicates the reception window, a flag in the one or more additional retransmissions of the data packet that indicates the one or more retransmissions of the data packet are canceled, or a second control data packet that indicates the one or more retransmissions of the data packet are canceled.

The processor 1300 may be configured to or operable to support at least one controller (e.g., the controller 1302) coupled with at least one memory (e.g., the memory 1304) and configured to cause the processor to transmit signaling that indicates a set of conditions for managing (e.g., enabling or canceling) inclusion of a poll bit in a header of a data packet at an RLC layer or for managing (e.g., transmitting or canceling) one or more retransmissions of the data packet at the RLC layer, and receive, based on one or more conditions of the set of conditions being satisfied, one or more of the data packet including the inclusion of the poll bit in the header of the data packet or the one or more retransmissions of the data packet.

Additionally, the processor 1300 may be configured to support any one or combination of the set of conditions includes at least one of a first threshold duration corresponding to including the poll bit in the header of the data packet at the RLC layer of the UE, a second threshold duration corresponding to receiving the one or more retransmissions of the data packet, a third threshold duration corresponding to canceling the one or more retransmissions of the data packet, a fourth threshold duration corresponding to canceling the inclusion of the poll bit in the header of the data packet at the RLC layer of the UE, or a threshold importance value of the data packet. Additionally, or alternatively, the processor 1300 may be configured to support one or more of: the first threshold duration is offset from the second threshold duration based on a minimum time associated with receiving a status report after transmitting the data packet including the poll bit; the second threshold duration is based on a minimum time associated with receiving the data packet; the third threshold duration is based on a minimum time between a retransmission of the data packet and the one or more retransmissions of the data packet; or the fourth threshold duration is based on a minimum time between a retransmission of the data packet and a transmission of the data packet including the poll bit in the header of the data packet. Additionally, or alternatively, the processor 1300 may be configured to support the first threshold duration is a same value as the second threshold duration. Additionally, or alternatively, the processor 1300 may be configured to support the signaling includes RRC signaling, where the set of conditions are configured in at least one of a PDCP IE or an RLC IE, and where one or more of the PDCP IE includes an autonomous retransmission timer parameter, the PDCP IE includes an enhanced polling timer parameter, the RLC IE includes an autonomous retransmission threshold parameter, or the RLC IE includes a delay critical poll parameter.

Additionally, or alternatively, the processor 1300 may be configured to support to transmit a status report including a NACK corresponding to the data packet, where one or more of the inclusion of the poll bit in the header of the data packet at the RLC layer of the UE is canceled or the one or more retransmissions of the data packet are canceled based on the NACK. Additionally, or alternatively, the processor 1300 may be configured to support the data packet including the inclusion of the poll bit in the header of the data packet is received, and where the processor 1300 may be configured to support to transmit, responsive to the poll bit, a status report including at least one of an ACK or NACK corresponding to the data packet. Additionally, or alternatively, the processor 1300 may be configured to support to receive a retransmission of the data packet based on the status report including the NACK, where the one or more retransmissions of the data packet are canceled, and where the one or more conditions include the status report including the NACK. Additionally, or alternatively, the processor 1300 may be configured to support to receive, independent of a status report, one or more additional retransmissions of the data packet. Additionally, or alternatively, the processor 1300 may be configured to support to transmit the status report including a NACK corresponding to the one or more additional retransmissions of the data packet, and update a reception window associated with the data packet based on at least one of a local timer, a first control data packet that indicates the reception window, a flag in the one or more additional retransmissions of the data packet that indicates the one or more retransmissions of the data packet are canceled, or a second control data packet that indicates the one or more retransmissions of the data packet are canceled.

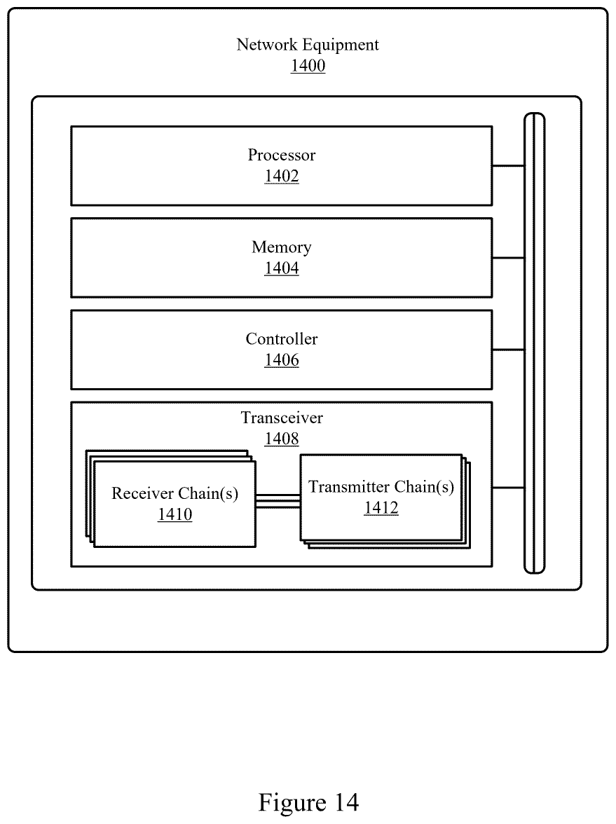

FIG. 14 illustrates an example of an NE 1400 in accordance with aspects of the present disclosure. The NE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the NE 1400 to perform various functions of the present disclosure.

The memory 1404 may include volatile or non-volatile memory. The memory 1404 may store computer-readable, computer-executable code including instructions when executed by the processor 1402 cause the NE 1400 to perform various functions described herein. The code may be stored in a non-transitory computer-readable medium such as the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the NE 1400 to perform one or more of the functions described herein (e.g., executing, by the processor 1402, instructions stored in the memory 1404). For example, the processor 1402 may support wireless communication at the NE 1400 in accordance with examples as disclosed herein. The NE 1400 may be configured to or operable to support a means for transmitting signaling that indicates a set of conditions for managing (e.g., enabling or canceling) inclusion of a poll bit in a header of a data packet at an RLC layer or for managing (e.g., transmitting or canceling) one or more retransmissions of the data packet at the RLC layer, and receiving, based on one or more conditions of the set of conditions being satisfied, one or more of the data packet including the inclusion of the poll bit in the header of the data packet or the one or more retransmissions of the data packet.

Additionally, the NE 1400 may be configured to support any one or combination of the set of conditions includes at least one of a first threshold duration corresponding to including the poll bit in the header of the data packet at the RLC layer of the UE, a second threshold duration corresponding to receiving the one or more retransmissions of the data packet, a third threshold duration corresponding to canceling the one or more retransmissions of the data packet, a fourth threshold duration corresponding to canceling the inclusion of the poll bit in the header of the data packet at the RLC layer of the UE, or a threshold importance value of the data packet. Additionally, or alternatively, the NE 1400 may be configured to support one or more of: the first threshold duration is offset from the second threshold duration based on a minimum time associated with receiving a status report after transmitting the data packet including the poll bit; the second threshold duration is based on a minimum time associated with receiving the data packet; the third threshold duration is based on a minimum time between a retransmission of the data packet and the one or more retransmissions of the data packet; or the fourth threshold duration is based on a minimum time between a retransmission of the data packet and a transmission of the data packet including the poll bit in the header of the data packet. Additionally, or alternatively, the NE 1400 may be configured to support the first threshold duration is a same value as the second threshold duration. Additionally, or alternatively, the NE 1400 may be configured to support the signaling includes RRC signaling, where the set of conditions are configured in at least one of a PDCP IE or an RLC IE, and where one or more of the PDCP IE includes an autonomous retransmission timer parameter, the PDCP IE includes an enhanced polling timer parameter, the RLC IE includes an autonomous retransmission threshold parameter, or the RLC IE includes a delay critical poll parameter.

Additionally, or alternatively, the NE 1400 may be configured to or operable to support a means for transmitting a status report including a NACK corresponding to the data packet, where one or more of the inclusion of the poll bit in the header of the data packet at the RLC layer of the UE is canceled or the one or more retransmissions of the data packet are canceled based on the NACK. Additionally, or alternatively, the NE 1400 may be configured to support the data packet including the inclusion of the poll bit in the header of the data packet is received, and where the NE 1400 may be configured to or operable to support a means for transmitting, responsive to the poll bit, a status report including at least one of an ACK or NACK corresponding to the data packet. Additionally, or alternatively, the NE 1400 may be configured to or operable to support a means for receiving a retransmission of the data packet based on the status report including the NACK, where the one or more retransmissions of the data packet are canceled, and where the one or more conditions include the status report including the NACK. Additionally, or alternatively, the NE 1400 may be configured to or operable to support a means for receiving, independent of a status report, one or more additional retransmissions of the data packet. Additionally, or alternatively, the NE 1400 may be configured to support to transmit the status report including a NACK corresponding to the one or more additional retransmissions of the data packet, and update a reception window associated with the data packet based on at least one of a local timer, a first control data packet that indicates the reception window, a flag in the one or more additional retransmissions of the data packet that indicates the one or more retransmissions of the data packet are canceled, or a second control data packet that indicates the one or more retransmissions of the data packet are canceled.

Additionally, or alternatively, the NE 1400 may support at least one memory (e.g., the memory 1404) and at least one processor (e.g., the processor 1402) coupled with the at least one memory and configured to cause the NE to transmit signaling that indicates a set of conditions for managing (e.g., enabling, canceling) inclusion of a poll bit in a header of a data packet at an RLC layer or for managing (e.g., transmitting, canceling) one or more retransmissions of the data packet at the RLC layer, and receive, based on one or more conditions of the set of conditions being satisfied, one or more of the data packet including the inclusion of the poll bit in the header of the data packet or the one or more retransmissions of the data packet.

Additionally, the NE 1400 may be configured to support any one or combination of the set of conditions includes at least one of a first threshold duration corresponding to enabling the inclusion of the poll bit in the header of the data packet at the RLC layer of the UE, a second threshold duration corresponding to receiving the one or more retransmissions of the data packet, a third threshold duration corresponding to canceling the one or more retransmissions of the data packet, a fourth threshold duration corresponding to canceling the inclusion of the poll bit in the header of the data packet at the RLC layer of the UE, or a threshold importance value of the data packet. Additionally, or alternatively, the NE 1400 may be configured to support one or more of: the first threshold duration is offset from the second threshold duration based on a minimum time associated with receiving a status report after transmitting the data packet including the poll bit; the second threshold duration is based on a minimum time associated with receiving the data packet; the third threshold duration is based on a minimum time between a retransmission of the data packet and the one or more retransmissions of the data packet; or the fourth threshold duration is based on a minimum time between a retransmission of the data packet and a transmission of the data packet including the poll bit in the header of the data packet. Additionally, or alternatively, the NE 1400 may be configured to support the first threshold duration is a same value as the second threshold duration. Additionally, or alternatively, the NE 1400 may be configured to support the signaling includes RRC signaling, where the set of conditions are configured in at least one of a PDCP IE or an RLC IE, and where one or more of the PDCP IE includes an autonomous retransmission timer parameter, the PDCP IE includes an enhanced polling timer parameter, the RLC IE includes an autonomous retransmission threshold parameter, or the RLC IE includes a delay critical poll parameter.

Additionally, or alternatively, the NE 1400 may be configured to support to transmit a status report including a NACK corresponding to the data packet, where one or more of the inclusion of the poll bit in the header of the data packet at the RLC layer of the UE is canceled or the one or more retransmissions of the data packet are canceled based on the NACK. Additionally, or alternatively, the NE 1400 may be configured to support the data packet including the inclusion of the poll bit in the header of the data packet is received, and where the NE 1400 may be configured to support to transmit, responsive to the poll bit, a status report including at least one of an ACK or NACK corresponding to the data packet. Additionally, or alternatively, the NE 1400 may be configured to support to receive a retransmission of the data packet based on the status report including the NACK, where the one or more retransmissions of the data packet are canceled, and where the one or more conditions include the status report including the NACK. Additionally, or alternatively, the NE 1400 may be configured to support to receive, independent of a status report, one or more additional retransmissions of the data packet. Additionally, or alternatively, the NE 1400 may be configured to support to transmit the status report including a NACK corresponding to the one or more additional retransmissions of the data packet, and update a reception window associated with the data packet based on at least one of a local timer, a first control data packet that indicates the reception window, a flag in the one or more additional retransmissions of the data packet that indicates the one or more retransmissions of the data packet are canceled, or a second control data packet that indicates the one or more retransmissions of the data packet are canceled.

The controller 1406 may manage input and output signals for the NE 1400. The controller 1406 may also manage peripherals not integrated into the NE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the NE 1400 may include at least one transceiver 1408. In some other implementations, the NE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas to receive a signal over the air or wireless medium. The receiver chain 1410 may include at least one amplifier (e.g., a low-noise amplifier (LNA)) configured to amplify the received signal. The receiver chain 1410 may include at least one demodulator configured to demodulate the receive signal and obtain the transmitted data by reversing the modulation technique applied during transmission of the signal. The receiver chain 1410 may include at least one decoder for decoding the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

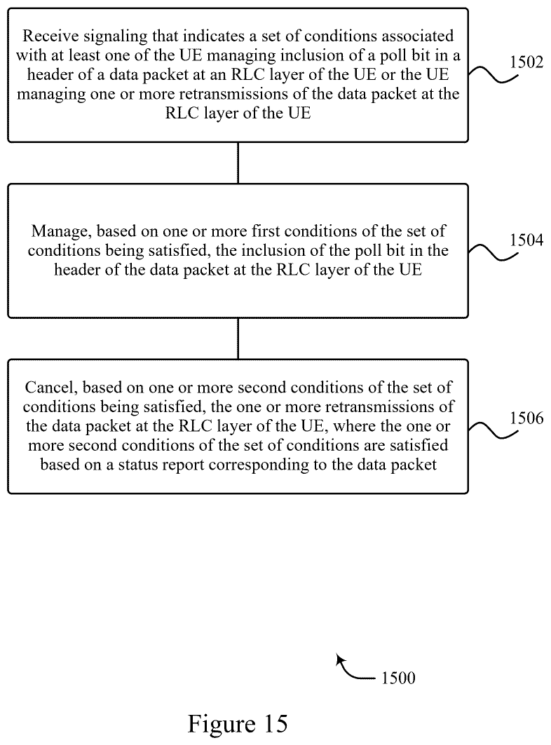

FIG. 15 illustrates a flowchart of a method 1500 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1502, the method may include receiving signaling that indicates a set of conditions associated with at least one of the UE managing (e.g., enabling or canceling) inclusion of a poll bit in a header of a data packet at an RLC layer of the UE or the UE managing (e.g., transmitting or canceling) one or more retransmissions of the data packet at the RLC layer of the UE. The operations of 1502 may be performed in accordance with examples as described herein. In some implementations, aspects of the operations of 1502 may be performed by a UE as described with reference to FIG. 12.

At 1504, the method may include managing (e.g., enabling or canceling), based on one or more first conditions of the set of conditions being satisfied, the inclusion of the poll bit in the header of the data packet at the RLC layer of the UE. The operations of 1504 may be performed in accordance with examples as described herein. In some implementations, aspects of the operations of 1504 may be performed by a UE as described with reference to FIG. 12.

At 1506, the method may include canceling, based on one or more second conditions of the set of conditions being satisfied, the one or more retransmissions of the data packet at the RLC layer of the UE, where the one or more second conditions of the set of conditions are satisfied based on a status report corresponding to the data packet. The operations of 1506 may be performed in accordance with examples as described herein. In some implementations, aspects of the operations of 1506 may be performed a UE as described with reference to FIG. 12.

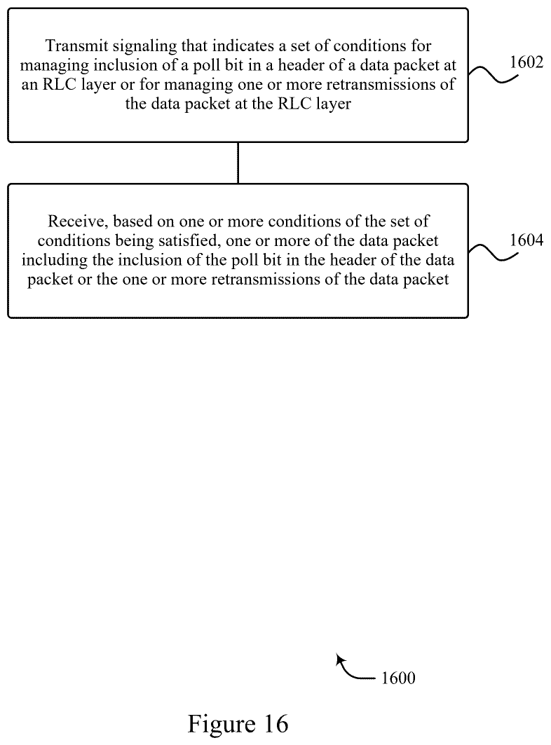

FIG. 16 illustrates a flowchart of a method 1600 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1602, the method may include transmitting signaling that indicates a set of conditions for managing (e.g., enabling or canceling) inclusion of a poll bit in a header of a data packet at an RLC layer or for managing (e.g., transmitting or canceling) one or more retransmissions of the data packet at the RLC layer. The operations of 1602 may be performed in accordance with examples as described herein. In some implementations, aspects of the operations of 1602 may be performed by an NE as described with reference to FIG. 14.

At 1604, the method may include receiving, based on one or more conditions of the set of conditions being satisfied, one or more of the data packet including the inclusion of the poll bit in the header of the data packet or the one or more retransmissions of the data packet. The operations of 1604 may be performed in accordance with examples as described herein. In some implementations, aspects of the operations of 1604 may be performed by an NE as described with reference to FIG. 14.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive signaling that indicates a plurality of conditions associated with at least one of the UE managing inclusion of a poll bit in a header of a data packet at a radio link control (RLC) layer of the UE or the UE managing one or more retransmissions of the data packet at the RLC layer of the UE;
manage, based at least in part on one or more first conditions of the plurality of conditions being satisfied, the inclusion of the poll bit in the header of the data packet at the RLC layer of the UE; and
cancel, based at least in part on one or more second conditions of the plurality of conditions being satisfied, the one or more retransmissions of the data packet at the RLC layer of the UE, wherein the one or more second conditions of the plurality of conditions are satisfied based at least in part on a status report corresponding to the data packet.

2. The UE of claim 1, wherein the plurality of conditions comprises at least one of a first threshold duration corresponding to including the poll bit in the header of the data packet at the RLC layer of the UE, a second threshold duration corresponding to transmitting the one or more retransmissions of the data packet at the RLC layer of the UE, a third threshold duration corresponding to canceling the one or more retransmissions of the data packet at the RLC layer of the UE, a fourth threshold duration corresponding to canceling the inclusion of the poll bit in the header of the data packet at the RLC layer of the UE, or a threshold importance value of the data packet.

3. The UE of claim 2, wherein one or more of:
the first threshold duration is offset from the second threshold duration based at least in part on a minimum time associated with receiving the status report after transmitting the data packet comprising the poll bit;
the second threshold duration is based at least in part on a minimum time associated with receiving the data packet at the RLC layer of the UE;
the third threshold duration is based at least in part on a minimum time between a retransmission of the data packet and the one or more retransmissions of the data packet; or
the fourth threshold duration is based at least in part on a minimum time between a retransmission of the data packet and a transmission of the data packet comprising the poll bit in the header of the data packet.

4. The UE of claim 3, wherein the first threshold duration is a same value as the second threshold duration.

5. The UE of claim 1, wherein the signaling comprises radio resource control (RRC) signaling, wherein the plurality of conditions are configured in at least one of a packet data convergence protocol (PDCP) information element (IE) or an RLC IE, and wherein one or more of the PDCP IE comprises an autonomous retransmission timer parameter, the PDCP IE comprises an enhanced polling timer parameter, the RLC IE comprises an autonomous retransmission threshold parameter, or the RLC IE comprises a delay critical poll parameter.

6. The UE of claim 1, wherein to cancel the one or more retransmissions of the data packet at the RLC layer of the UE, the at least one processor is further to cause the UE to receive the status report, wherein the status report comprises a negative acknowledgment (NACK) corresponding to the data packet, wherein at least one of the one or more first conditions or the one or more second conditions are satisfied based at least in part on the status report comprising the NACK corresponding to the data packet, and wherein the NACK triggers a retransmission of the data packet.

7. The UE of claim 1, wherein to manage the inclusion of the poll bit in the header of the data packet, the at least one processor is further to cause the UE to:
include the poll bit in the header of the data packet; and
receive, responsive to the poll bit, the status report, wherein the status report comprises at least one of an acknowledgement (ACK) or negative acknowledgement (NACK) corresponding to the data packet.

8. The UE of claim 7, wherein to cancel the one or more retransmissions of the data packet at the RLC layer of the UE, the at least one processor is further configured to cause the UE to retransmit the data packet based at least in part on the status report comprising the NACK, wherein the one or more second conditions comprise the status report comprising the NACK.

9. The UE of claim 1, wherein the at least one processor is further configured to cause the UE to transmit, independent of the status report, one or more additional retransmissions of the data packet.

10. The UE of claim 9, wherein to manage the one or more retransmissions of the data packet, the at least one processor is further configured to cause the UE to:
receive, after the one or more retransmissions of the data packet, the status report, wherein the status report comprises a negative acknowledgement (NACK) corresponding to the data packet, and wherein the one or more second conditions comprise the status report comprising the NACK; and
cancel, based at least in part on the status report, the one or more additional retransmissions of the data packet at the RLC layer of the UE.

11. The UE of claim 9, wherein the at least one processor is further configured to cause the UE to:
discard, after the one or more additional retransmissions of the data packet and independent of the status report corresponding to the data packet, the data packet; and
update a transmission window associated with the data packet.

12. The UE of claim 9, wherein the at least one processor is further configured to cause the UE to:
receive the status report, wherein the status report comprises a negative acknowledgement (NACK) corresponding to the one or more additional retransmissions of the data packet; and
update, independent of the NACK, a transmission window associated with the data packet, wherein a reception window is based at least in part on at least one of a local timer, a first control data packet that indicates the reception window, a flag in the one or more additional retransmissions of the data packet that indicates the one or more retransmissions of the data packet are canceled, or a second control data packet that indicates the one or more retransmissions of the data packet are canceled.

13. A processor for wireless communication, comprising:
at least one controller coupled with at least one memory and configured to cause the processor to:
receive signaling that indicates a plurality of conditions associated with at least one of the processor managing inclusion of a poll bit in a header of a data packet at a radio link control (RLC) layer of the processor or the processor managing one or more retransmissions of the data packet at the RLC layer of the processor;
manage, based at least in part on one or more first conditions of the plurality of conditions being satisfied, the inclusion of the poll bit in the header of the data packet at the RLC layer of the processor; and
cancel, based at least in part on one or more second conditions of the plurality of conditions being satisfied, the one or more retransmissions of the data packet at the RLC layer of the processor, wherein the one or more second conditions of the plurality of conditions are satisfied based at least in part on a status report corresponding to the data packet.

14. The processor of claim 13, wherein the plurality of conditions comprises at least one of a first threshold duration corresponding to including the poll bit in the header of the data packet at the RLC layer of the processor, a second threshold duration corresponding to transmitting the one or more retransmissions of the data packet at the RLC layer of the processor, a third threshold duration corresponding to canceling the one or more retransmissions of the data packet at the RLC layer of the processor, a fourth threshold duration corresponding to canceling the inclusion of the poll bit in the header of the data packet at the RLC layer of the processor, or a threshold importance value of the data packet.

15. The processor of claim 14, wherein one or more of:
the first threshold duration is offset from the second threshold duration based at least in part on a minimum time associated with receiving the status report after transmitting the data packet comprising the poll bit;
the second threshold duration is based at least in part on a minimum time associated with receiving the data packet at the RLC layer of the processor;
the third threshold duration is based at least in part on a minimum time between a retransmission of the data packet and the one or more retransmissions of the data packet; or
the fourth threshold duration is based at least in part on a minimum time between a retransmission of the data packet and a transmission of the data packet comprising the poll bit in the header of the data packet.

16. The processor of claim 13, wherein the signaling comprises radio resource control (RRC) signaling, wherein the plurality of conditions are configured in at least one of a packet data convergence protocol (PDCP) information element (IE) or an RLC IE, and wherein one or more of the PDCP IE comprises an autonomous retransmission timer parameter, the PDCP IE comprises an enhanced polling timer parameter, the RLC IE comprises an autonomous retransmission threshold parameter, or the RLC IE comprises a delay critical poll parameter.

17. The processor of claim 13, wherein to cancel the one or more retransmissions of the data packet at the RLC layer of the processor, the at least one controller is further to cause the processor to receive the status report, wherein the status report comprises a negative acknowledgment (NACK) corresponding to the data packet, wherein at least one of the one or more first conditions or the one or more second conditions are satisfied based at least in part on the status report comprising the NACK corresponding to the data packet, and wherein the NACK triggers a retransmission of the data packet.

18. The processor of claim 13, wherein to manage the inclusion of the poll bit in the header of the data packet, the at least one controller is further to cause the processor to:
include the poll bit in the header of the data packet; and
receive, responsive to the poll bit, the status report, wherein the status report comprises at least one of an acknowledgement (ACK) or negative acknowledgement (NACK) corresponding to the data packet.

19. A method performed by a user equipment (UE), the method comprising:
receiving signaling that indicates a plurality of conditions associated with at least one of the UE managing inclusion of a poll bit in a header of a data packet at a radio link control (RLC) layer of the UE or the UE managing one or more retransmissions of the data packet at the RLC layer of the UE;
managing, based at least in part on one or more first conditions of the plurality of conditions being satisfied, the inclusion of the poll bit in the header of the data packet at the RLC layer of the UE; and
canceling, based at least in part on one or more second conditions of the plurality of conditions being satisfied, the one or more retransmissions of the data packet at the RLC layer of the UE, wherein the one or more second conditions of the plurality of conditions are satisfied based at least in part on a status report corresponding to the data packet.

20. A network equipment (NE) for wireless communication, comprising:
at least one memory; and
at least one processor coupled with the at least one memory and configured to cause the NE to:
transmit signaling that indicates a plurality of conditions for managing inclusion of a poll bit in a header of a data packet at a radio link control (RLC) layer of the UE or the UE managing one or more retransmissions of the data packet at the RLC layer of the UE; and
receive, based at least in part on one or more conditions of the plurality of conditions being satisfied, one or more of the data packet comprising the inclusion of the poll bit in the header of the data packet or the one or more retransmissions of the data packet.
